(19) United States
(12) Patent Application Publication
(10) Pub. No.: US 2004/0223173 A1
(43) Pub. Date: Nov. 11, 2004

(54) Generating method for color conversion table, method and apparatus for creating correspondence definition data

(75) Inventor: Yoshifumi Arai, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/686,817

(22) Filed: Oct. 17, 2003

(30) Foreign Application Priority Data
Oct. 17, 2002 (JP) 2002-302471
Oct. 17, 2002 (JP) 2002-302472

(51) Int. Cl. G06F 15/00; G06K 15/00

(52) U.S. Cl. 358/1.9; 358/3.01; 358/518; 358/3.23

(57) ABSTRACT

When the resolution for a specific gradation is enhanced, the resolution for the other gradations can be relatively degraded. It used to be difficult to carry out color conversion with accuracy in the high-lightness range without the occurrence of tone jump. A color conversion table which defines the correspondence between ink value data which specifies the ink quantities of inks in individual colors used in a printing device and the color component values of various colors used in another image device is generated. At this time, correction for interpolation accuracy enhancement is carried out beforehand so that colors in the low-lightness range will be larger in number than colors in the high-lightness range. This is intended to compensate the resolution which is relatively degraded in the low-lightness range by correction for resolution enhancement by interpolation accuracy. Thereafter, correction for resolution enhancement is carried out to create the ink value data. Patches printed based on the ink value data are subjected to color measuring to generate a color conversion table. When correspondence definition data is created, first gradation value data wherein the magnitude of gradation values and the ink quantity are in substantially linear correspondence with each other is acquired. Further, the first gradation value data is subjected to γ correction with a higher rate of increase applied to a smaller gradation value. Thus, ink value data wherein the relative resolution in the high-lightness range is enhanced is created.

### BACKGROUND OF THE INVENTION

1. Field of the Invention

The present invention relates to a generating method for color conversion table, a print controller, a color conversion table generator, a medium with a color conversion table generating program recorded thereon, a method and an apparatus for creating correspondence definition data, and a medium with a correspondence definition data creating program recorded thereon.

2. Description of the Prior Art

Image devices, such as displays and printers, usually use color image data which renders the color of each pixel using specific color components with gradations. Colors are defined in various color spaces to obtain image data. Such color spaces include, for example, RGB color space and CMY-based color space. In the RGB color space, three colors, R (Red), G (Green), and B (Blue) are used. In the CMY-based color space, C (cyan)-based colors, M (magenta)-based colors, and Y (yellow)-based colors (including lc (light cyan), lm (light magenta), DY (dark yellow), and K (black)) are used. In general, these colors are equipment-dependent colors which are specific to each image device. Therefore, to output the same images in the same colors with different image devices, color conversion tables (LUTs) are used. Color conversion tables define color correspondence between devices.

Displays which utilize a RGB color space and printers which utilize a CMY-based color space are different from each other in color developing method (additive color mixture or subtractive color mixture) and color gamut. Thus, the properties of colors are different between the spaces, and it is not easy to naturally and accurately carry out color conversion.

To cope with this, various methods have been devised. One of such methods is such that: when color conversion is carried out, gradation values are augmented, and when half tone processing is performed, the augmented portion is eliminated. Thus, the resolution for specific shades of gray is substantially enhanced. (Refer to Japanese Patent Application No. 2000-307859.)

Another method is to enhance the color reproducibility in color conversion also with respect to input colors out of a color gamut. (Refer to Japanese Patent Prepublication No. 2001-228296.)

If it is assumed that the storage capacity available for rendering shades of gray in each color is definite, in case of the former, a problem can arise. When the resolution for specific shades of gray is enhanced by augmentation as mentioned above, the resolution for the other shades of gray can be relatively lowered.

In the latter conventional color conversion, it is difficult to accurately control the lightness of each color ink by a density gradation rendering method. More specific description will be given. In case print operation is performed with a printer or the like, the shades of gray in each color are rendered by adjusting the count of dots recorded per unit area with respect to each ink color of CMYKlclm or the like. However, fluctuation in lightness to the unit fluctuation in dot count is different between in a high-lightness range and in a low-lightness range. If a gradation value with the same resolution is used in both the lightness ranges, it is difficult to control colors in the high-lightness range with accuracy.

More specific description will be given. The lightness of a print is influenced by the color of the printing medium and recorded ink droplets. Two cases will be compared: a case where the quantity of ink droplets is increased from A to A+1 at a high lightness, that is, low ink recording rate and a case where the quantity of ink droplets is increased from B to B+1 at a low lightness, that is, a high ink recording rate. The lightness is more greatly influenced in the former case. This is because (A+1)/A is larger than (B+1)/B. Further, at a high ink recording rate, areas where ink droplets overlap with one another are increased. Therefore, also in this sense, influences on the lightness are reduced.

For the above-mentioned reasons, the accuracy in a high-lightness range is inferior to that in a low-lightness range unless ink quantities are more deliberately controlled. Conventionally, the gradation value of ink quantity for identifying ink quantities is set to 256 levels. Then, variations in ink quantity equivalent to variation by one shade of gray are made equal in all the lightness ranges. (That is, variations are in substantially linear correspondence.) Further, in the above-mentioned LUT, representative reference points are defined from among these gradation values. For an arbitrary color, the ink quantity gradation value is calculated by interpolation utilizing these reference points. Therefore, in a high-lightness range, relatively large errors are contained because of utilization of data with lower resolution than in a low-lightness range as well as interpolation.

### SUMMARY OF THE INVENTION

A first object of the present invention is to provide a generating method for color conversion table, a print controller, a color conversion table generator, and a color conversion table generating program wherein correspondence for carrying out color conversion with accuracy in all the lightness ranges can be defined.

According to the present invention, the following procedures are taken when a color conversion table is generated to attain the above-mentioned first object: reference values before correction extracted from predetermined gradation values before correction are subjected to correction for interpolation accuracy enhancement. Then, patch data of colors determined by bringing the magnitude of corrected gradation values for interpolation accuracy enhancement and the magnitude of ink quantities into substantially linear correspondence. Further, the gradation values in the patch data are defined as integral values existing in a predetermined range of value. This definition is made so that a gradation value corresponding to a higher-lightness range will be reduced in variation in the ink recording rate corresponding to the unit variation in that gradation value as compared with gradation values corresponding to a lower-lightness range. Then, the defined gradation values are taken as ink value data. Ink quantities corresponding to the reference values of the patch data are interpreted according to the definition of the gradation values. Thereby, half tone image data is created, and a color conversion table is generated.

More specific description will be given. In the ink value data, gradation values are redefined so that gradation values corresponding to a high-lightness range and gradation values corresponding to a low-lightness range will be different from each other in variation in ink recording rate denoted by the unit variation in gradation value. Thereby, subtler variations in ink recording rate can be represented in a higher-lightness range. In this case, however, the resolution in the low-lightness range is inferior to that in the high-lightness range as compared with the following cases: cases where with respect to gradation values represented with a limited capacity (e.g. 8 bits, 256 levels), the unit variation and variation in the ink recording rate thereof are substantially equal to each other. According to the present invention, correction for interpolation accuracy enhancement is carried out beforehand to increase pieces of patch data corresponding to colors in a low-lightness range to cope with this. Then, the colors are subjected to color measuring.

At this time, a smaller number of reference values before correction than the total number of the levels of predetermined gradation value before correction are extracted from the gradation values before correction with respect to each ink color. Then, the reference values before correction are combined. As a result, a plurality of data sets consisting of combinations of a plurality of reference values before correction are obtained. Then, the data sets are subjected to correction for interpolation accuracy enhancement. In the correction for interpolation accuracy enhancement, reference values before correction are increased. Therefore, if it is assumed that the magnitude of values and ink quantity is in substantially linear correspondence with respect to the reference values before correction, the numbers of colors are in the following relation: colors indicated by data after correction for interpolation accuracy enhancement are larger in number than colors indicated by the individual data sets in a low-lightness range.

When patch data is printed utilizing more colors in a low-lightness range than those in a high-lightness range, the interpolation accuracy in generating a color conversion table is higher in the low-lightness range. To bring ink value data into correspondence with the color component values of various colors used in the above-mentioned another image device based on a color measuring result, interpolation is utilized. If there are a large number of colors in a low-lightness range, accurate interpolation can be carried out with respect to the colors in the low lightness range. Further, interpolation is also carried out when color conversion is carried out using the color conversion table. Therefore, if colors are determined with accuracy in the low-lightness range, color conversion can be carried out with accuracy.

As gradation values before correction, for example, the gradation values of the individual color components in a color space consisting of three color components can be adopted. To adopt colors which are substantially uniformly distributed throughout a color space when the intensity of each color component is linearly represented by gradation value, gradation values obtained by substantially equally dividing the gradation value range can be combined. In this case as well, the resolution in the low-lightness range is relatively lowered if ink value data is defined as mentioned above.

Consequently, the gradation values obtained by substantially equally dividing the gradation value range are subjected to correction for resolution enhancement. Thus, representative colors can be extracted so that colors in the low-lightness range will be more densely distributed than those in the high-lightness range as compared with those before correction. Needless to add, even if the data is not a combination of gradation values obtained by substantially equally dividing the gradation value range as mentioned above, colors in the low-lightness range can be increased in number. Thereby, the interpolation accuracy in the low-lightness range can be enhanced. For example, even if the data is obtained by carrying out color separation described later, the colors can be increased in number, and the interpolation accuracy can be enhanced. This is done by carrying out correction for interpolation accuracy enhancement.

In any case, subtler variations in ink recording rate can be represented in the high-lightness range by the correction for interpolation accuracy enhancement and the definition of ink value data. In addition, degradation in resolution in the low-lightness range can be also prevented. As a result, correspondence for carrying out color conversion with accuracy in all the lightness ranges can be defined by color conversion table. Ink value data is defined as integral values existing in a predetermined range of value. Therefore, the total number of gradations is limited. For example, if gradation values are represented with the capacity of 8 bits, the total number of gradations is 256 with respect to each color. Then, gradations can be defined with integral values of 0 to 255 or the like.

Patch data is created by a number of patches to be subjected to color measuring. However, it is impossible in effect to extract reference values equivalent to the total number of gradations in ink value data to obtain patch data. More specific description will be given. 256-step gradation, which is presently the most common number of gradations, will be taken as an example. In this case, as many pieces of patch data as 256^{x} (x is a number of ink colors) are required to extract reference values equivalent to the total number of gradations to obtain patch data. It is impossible in effect to subject this vast number of patches to color measuring. Consequently, a smaller number of reference values than the total number of gradations are extracted with respect to each ink, and, for example, 1,000 pieces of patch data is created.

The gradation values in the ink value data are in correspondence with ink quantities. That is, an ink quantity is determined by a gradation value. Therefore, if gradation values are combined on an ink color-by-ink color basis, an ink quantity is determined with respect to each ink color. Thus, colors rendered when print operation is performed with these ink quantities are defined. Further, in ink value data, gradation values only have to be capable of being defined so that a gradation value corresponding to a higher-lightness range will be reduced in variation in the ink recording rate corresponding to the unit variation in that gradation value as compared with gradation values corresponding to a lower-lightness range.

A concrete example will be taken. The unit variation in gradation values will be set to “1,” which is the minimum variation in integral values. In this case, accurate color conversion in the high-lightness range can be implemented by making a definition so that: when the gradation value varies by “1” in the high-lightness range, the ink recording rate will vary by m % or less, and when the gradation value varies by “1” in the low-lightness range, the ink recording rate will vary by more than m %. With the above-mentioned definition, the ink recording rate can be defined with accuracy in the high-lightness range even if the gradation values are defined as integral values existing in a predetermined range of value. By generating the above-mentioned color conversion table based on this definition, accurate color conversion can be carried out even at a high lightness.

More specific description will be given. If gradation values are defined by computer, the range thereof is limited, and usually, values are defined by integers. It is assumed that variation in ink recording rate corresponding to the unit variation in gradation value is substantially constantly defined in all the lightness ranges, as in conventional cases. In this case, the accuracy is more degraded in the high-lightness range than in the low-lightness range due to the characteristics of lightness variation to variation in ink recording rate. However, by defining gradation values according to the present invention, ink recording rates can be defined with accuracy at high lightness without expanding the range of gradation value.

An example will be taken. 256 shades of gray can be rendered with a storage capacity of 8 bits. If the ink recording rate of 0 to 100% is uniformly allocated to individual gradations of 0 to 256, the resolution is uniform. Alternatively, not 256*n/100 but a greater value is brought into correspondence with the ink recording rate of n % (n is an example of the high-lightness range). For example, 40, not 13 (≅256*5/100), is brought into correspondence with the ink recording rate of 5%, and 61, not 26 (≅256*10/100) is brought into correspondence with the ink recording rate of 10%. Thus, the ink recording rate of 5 to 10% can be represented in 21 levels, not 13 levels. If 256 shades of gray are rendered with 8 bits, each gradation value is an integral value, and the fractional portion thereof is dropped or rounded off.

If this idea is applied to creation of a color conversion table, color conversion can be highly accurately carried out in the high-lightness range where the rate of change in lightness to variation in ink quantity is high. Once the gradation value and the ink recording rate are brought into correspondence with each other by the above-mentioned definition, colors to be printed can be determined by defining a gradation value with respect to each ink color. Meanwhile, by combining the color component values (e.g. the color component values of RGB colors, the color component values of CMYK colors, etc.) of various colors used in the above-mentioned another image device, colors in the another image device are determined. Consequently, by brining combinations of gradation values and combinations of the above-mentioned color component values into correspondence with each other, table data or profiles for color conversion between them can be created.

In the above-mentioned half tone processing, the presence or absence of dots recorded is determined with respect to individual pixels in a matrix pattern according to ink recording rates defined by the gradation values. Therefore, by defining the gradation values as mentioned above and performing print operation according to the output value of a half tone processing module, the ink recording rate can be finely controlled at high lightness during the print operation. Further, a color conversion table generated by the above-mentioned definition can be referred to when the color component values in the another image device is subjected to color conversion. Thus, colors at high lightness can be converted with accuracy. The ink recording rate is equivalent to the area of dots or the count of dots recorded per unit area. 0% is taken as a state in which no dot is recorded per unit area, and 100% is taken as a state in which the maximum number of dots are recorded per unit area.

Variation in lightness to the unit variation in ink recording rate at high lightness is greater than variation in lightness to the unit variation in ink recording rate at low lightness. For this reason, with respect to ordinary inks, the lightness hardly varies in a predetermined lightness range containing the lowest lightness that can be represented in each ink color even if the ink recording rate is varied. Consequently, the predetermined lightness range containing the lowest lightness that can be represented in ink colors may be excluded when the above-mentioned ink value data is defined.

More specifically, all the gradation values are allocated to a part of the range of value of ink recording rate when the above-mentioned ink value data is defined. Thus, ink recording rates at which substantial variation in lightness cannot be represented on a printing medium can be excluded. Then, gradation values can be allocated only to ink quantities with which the lightness can substantially vary. Therefore, ink quantities can be effectively represented in levels with a limited capacity, and subtler variation in gradation can be represented.

The range of value of ink recording rate is defined with a state in which no ink is recorded on a printing medium taken as the minimum ink recording rate and a state in which inks are recorded on a printing medium to the maximum taken as the maximum ink recording rate. For simplicity's sake, a range of value common to all the ink colors may be adopted as a part of the range of value of ink recording rate. Or, in consideration of ink-by-ink difference in the rate of change in lightness, a different range of value may be adopted as the above-mentioned part of the range of value of ink recording rate with respect to each ink.

In the present invention, the resolution for low lightness which is relatively lowered only has to be capable of being compensated. As mentioned above, this is done by making a definition so that a gradation value corresponding to a higher-lightness range will be reduced in variation in the ink recording rate corresponding to the unit variation in that gradation value as compared with gradation values corresponding to a lower-lightness range. For this reason, such a constitution as according to a third aspect of the present invention may be adopted. That is, the ink quantity and the magnitude of gradation values may be brought into substantially linear correspondence, and further many colors in the low-lightness range may be contained in first gradation value data that specifies colors to be subjected to color measuring. More specific description will be given. By the above-mentioned correction for resolution enhancement, the resolution in the high-lightness range is enhanced, but the resolution in the low-lightness range is degraded. To cope with this, the first gradation value data is extracted beforehand so that colors in the low-lightness range are larger in number than colors in the high-lightness range. Then, the resolution which is relatively lowered in the low-lightness range is compensated by interpolation accuracy.

More specific description will be given. If the ink quantity and the magnitude of gradation values are brought into substantially linear correspondence, the higher the gradation value becomes, the more the ink quantity is increased, which lowers the lightness of colors. Therefore, the correction for interpolation accuracy enhancement is equivalent to increasing colors at low lightness. Consequently, colors at low lightness can be increased beforehand. Thus, interpolation can be carried out with accuracy in the low-lightness range when colors specified by the first gradation value data are subjected to color measuring to generate a color conversion table.

The first gradation value data in this state is corrected to obtain ink value data. At this time, a higher rate of increase is applied to gradation values corresponding to a higher-lightness range than that applied to gradation values corresponding to a lower-lightness range. In this ink value data, a definition can be made so that a gradation value corresponding to a higher-lightness range will be reduced in the ink recording rate corresponding to the unit variation in that gradation value as compared with gradation values corresponding to a lower-lightness range. Therefore, the resolution in the high-lightness range can be enhanced.

When an object of color measuring is printed based on this ink value data, a deviation equivalent to the fractional portion obtained when inverse correction to correction for resolution enhancement is carried out can be reflected during half tone processing. As a result, the data after inverse correction is the same as in a state in which the ink recording rate of 0 to 100% is uniformly allocated to the gradations of 0 to 256. Thus, the ink recording rate can be grasped from the individual gradation values to determine ink quantities. However, the situation in which the resolution is high at high lightness is maintained. This is because a deviation equivalent to the fractional portion obtained when inverse correction is carried out is reflected during the half tone processing.

Needless to add, a deviation equivalent to the fractional portion obtained when inverse correction is carried out cannot be indefinitely considered. However, colors can be determined with accuracy by considering the fractional portion to a predetermined digit according to the capability available in half tone processing. At this time, a deviation equivalent to the fractional portion obtained when inverse correction is carried out only has to be capable of being considered. Instead of such a constitution that inverse correction is actually carried out, other constitutions may be adopted. For example, values obtained by determining the ink recording rate corresponding to each piece of the corrected ink value data mentioned above to a higher number of bits may be stored beforehand. With these constitutions as well, accurate color conversion can be carried out in all the lightness ranges. Though ink value data is subjected to correction for resolution enhancement, inverse correction is carried out in half tone processing. Therefore, colors indicated by the ink value data and colors indicated by the first gradation value data are identical with each other.

In the present invention, color separation processing may be performed when the first gradation value data is determined. More specific description will be given. Printing devices are often so constituted that print operation can be performed using a larger number of ink colors than three colors of CMY, for example, six or seven color inks. It is difficult to specify an object of color measuring in a six-dimensional or seven-dimensional space. This is because when six or seven color inks are used, alternatively used inks, such as cyan and light cyan, are included, and different combinations of six or seven colors often renders substantially the same color.

It is difficult to formulate a required transformation expression, such as a matrix, for univocally transforming coordinate values in a six-dimensional space into coordinate values in a three-dimensional space. However, it is easy to formulate a transformation expression for univocally transforming coordinate values in a three-dimensional space into coordinate values in a six-dimensional space. Therefore, it is very easy to specify colors to be subjected to color measuring in three colors of CMY and carry out color separation to convert a combination of the three colors into a combination of six or seven colors by specific transformation expressions.

Consequently, such a constitution that colors to be subjected to color measuring are specified by CMY values and then color separation is carried out to transform the CMY values can be adopted. At this time, the CMY values before color separation or the values after color separation are subjected to correction for resolution enhancement. Thereby, colors in the low-lightness range are made larger in number than colors in the high-lightness range so that the resolution which is relatively degraded in the low-lightness range will be compensated by interpolation accuracy. Thus, the ink values for patches to be printed can be easily determined by color separation, and the present invention can be applied with ease. Original colors before color separation are rendered by combinations of CMY colors, and thus the above-mentioned constitution is desirable because any color can be rendered. Needless to add, other color systems (e.g. RGB color system) than the CMY space may be adopted to create the first gradation value data as long as the following conditions are satisfied: conversion into combinations of color inks used in the printing device should be facilitated, and coordinates in a predetermined color space constituted of a smaller number of color components than the number of ink colors should be transformed.

Color measuring only has to be capable of acquiring the chromatic values of print results. It only has to be capable of obtaining color measuring data which indicates coordinates in a non-equipment-dependent color space, such as the Lab color space. (* is usually affixed to L, a, and b, respectively but it is omitted in this specification for simplicity's sake. This is the same with the following description.) When a color conversion table is generated, color measuring data which indicates coordinates in the non-equipment-dependent color space and coordinates in the non-equipment-dependent color space indicated by color data used in another image device can be used.

More specific description will be given. It is assumed that the coordinates of a plurality of colors in a non-equipment-dependent color space are known. In this case, ink value data of arbitrary colors and the color component values of various colors used in another image device can be calculated by interpolation or the like. Therefore, with respect to an arbitrary color, correspondence between them can be calculated to define a color conversion table. With respect to the color component values of colors used in another image device, coordinates in the non-equipment-dependent color space must be acquired. Therefore, the data is preferably data in conformity with the sRGB standard with which data coordinates in the non-equipment-dependent color space can be calculated by predetermined expressions. Needless to add, the display colors of the another image device may be subjected to color measuring.

As mentioned above, various constitutions can be adopted for carrying out the above-mentioned correction for resolution enhancement. For example, the first gradation value data can be extracted beforehand so that colors in the low-lightness range will be larger in number than colors in the high-lightness range. Thereby, the resolution which is relatively degraded in the low-lightness range by correction for resolution enhancement is compensated by interpolation accuracy. One example of such constitutions available is γ correction. The γ correction is correction wherein a numeric value within a predetermined range of value is inputted, and the result obtained by transforming the input value by predetermined functions is outputted. It utilizes functions which give a γ curve. According to the γ curve, correction wherein a smaller input value is corrected with a higher rate of increase than that for input values greater than the input value only by adjustment of the value of γ and the corrected value is outputted can be carried out with ease. Further, the degree of the correction can be adjusted with ease. Thus, the γ curve is convenient. When γ correction is actually carried out, an input value may be substituted into functions which give a γ curve. Or, data obtained beforehand by tabulating the result of γ correction may be referred to. In the present invention, the above-mentioned correction for acquiring the first gradation value data is referred to as “(γ) correction for interpolation accuracy enhancement.” Needless to add, however, the interpolation accuracy is enhanced by correction for resolution enhancement as well.

Needless to add, as a constitution wherein correction, such as γ correction, is carried out, a constitution wherein gradation values are allocated only to ink quantities with which the lightness can substantially vary, as mentioned above, can be adopted. More specific description will be given. It is assumed that in the first gradation value data, a gradation value which indicates the lowest lightness corresponds to the maximum ink recording rate at which inks can be recorded on a printing medium. If the predetermined gradation value range containing the gradation value which indicates the lowest lightness is excluded at this time, it turns out that a part on the low lightness side is excluded from the gradation value range.

Then, correction is carried out so that the remaining gradation value range is matched with the entire gradation value range of the ink value data. Thus, all the gradation values in ink value data can be allocated to the remaining gradation value range, that is, the lightness which substantially varies. Therefore, ink quantities can be effectively represented in levels with a limited capacity, and subtler variation in gradation can be represented.

As mentioned above, according to the present invention, ink value data which indicates ink quantities with which patches to be subjected to color measuring are printed is created. In half tone processing, the ink quantities denoted by the ink value data are interpreted to perform print operation. Then, the thus obtained patches are subjected to color measuring to generate a color conversion table. The present invention also functions as a print controller which carries out color conversion referring to this color conversion table and performs print operation. That is, by referring to this color conversion table, color conversion can be accurately carried out with respect to colors at high lightness and low lightness during print operation. Then, tone jump can be prevented from occurring in all the lightness ranges.

Further, it can be said that an apparatus which generates the above-mentioned color conversion table utilizes the technical philosophy of the present invention. A color conversion table generator corresponding to the third aspect may be constituted in accordance with an eighth aspect of the present invention. Needless to add, constitutions in accordance with fourth to seventh aspects of the present invention are possible. Such a color conversion table generator may be solely implemented, or may be incorporated into some equipment and implemented together with another apparatus or method. Thus, the philosophy of the present invention is not limited to these aspects but can be implemented in various embodiments. The embodiments of the present invention can be modified as appropriate, and the present invention may be embodied in software or in hardware.

A second object of the present invention takes the latter problems into account. The second object is to provide a creating method for correspondence definition data, a print controller, a correspondence definition data creating apparatus, and a correspondence definition data creating program wherein correspondence for carrying out color conversion with accuracy in the high-lightness range can be defined.

According to the present invention, input gradation values are defined as integral values existing in a predetermined range of value to attain the second object. Further, this definition is made so that an input gradation value corresponding to a higher-lightness range is reduced in variation in the ink recording rate corresponding to the unit variation in that input gradation value as compared with input gradation values corresponding to a lower-lightness range. More specific description will be given. Input gradation values corresponding to a high-lightness range and input gradation values corresponding to a low-lightness range are different from each other in variation in ink recording rate denoted by the unit variation in gradation value. Subtler variation in ink recording rate can be represented in a higher-lightness range.

An example will be taken. The unit variation in input gradation value will be set to “1,” which is the minimum variation in integral value. In this case, accurate color conversion in the high-lightness range can be implemented by making a definition so that: when the input gradation value varies by “1” in the high-lightness range, the ink recording rate will vary by 1% or less, and when the input gradation value varies by “1” in the low-lightness range, the ink recording rate will vary by more than 1%. With the above-mentioned definition, the ink recording rate can be defined with accuracy in the high-lightness range even if the input gradation values are defined as integral values existing in a predetermined range of value. By creating the above-mentioned correspondence definition data based on this definition, accurate color conversion can be carried out even at high lightness.

More specific description will be given. If gradation values are defined by computer, the range thereof is limited (e.g. 8 bits, 256 levels), and usually, values are defined by integers. It is assumed that variation in ink recording rate corresponding to the unit variation in gradation value is substantially constantly defined in all the lightness ranges, as in conventional cases. In this case, the accuracy is more degraded in the high-lightness range than in the low-lightness range. However, by defining input gradation values according to the present invention, ink recording rates can be defined with accuracy at high lightness without expanding the range of input gradation value.

Once the input gradation value and the ink recording rate are brought into correspondence with each other by the above-mentioned definition, colors to be printed can be determined by defining an input gradation value with respect to each ink color. Meanwhile, by combining the color component values (e.g. the color component values of RGB colors, the color component values of CMYK colors, etc.) of various colors used in the above-mentioned another image device, colors in the another image device are determined. Consequently, by bringing combinations of input gradation values and combinations of the color component values into correspondence with each other, table data or profiles for color conversion between them can be created.

The input gradation values are input values to a half tone processing module. The half tone processing module is a module which determines the presence or absence of dots recorded with respect to individual pixels in a matrix pattern according to ink recording rates defined by the input gradation values. Therefore, by defining the input gradation values as mentioned above and performing print operation according to the output value of the half tone processing module, the ink recording rate can be finely controlled at high lightness during the print operation.

Further, correspondence definition data created by the above-mentioned definition can be referred to when the color component values in the another image device is subjected to color conversion. Thus, colors at high lightness can be converted with accuracy. The ink recording rate is equivalent to the area of dots or the count of dots recorded per unit area. 0% is taken as a state in which no dot is recorded per unit area, and 100% is taken as a state in which the maximum number of dots are recorded per unit area.

As a method for creating correspondence definition data by the similar definition, color measuring on patch data may be utilized. For example, a plurality of patches outputted from a printing device are subjected to color measuring. Correspondence definition data can be created from the result of this color measuring. The correspondence definition data defines correspondence between the color component values of various colors used in another image device and gradation values corresponding to the ink quantities of inks in individual ink colors used in the printing device. At this time, a smaller number of reference values than the total number of gradation values corresponding to the ink quantities are extracted with respect to each ink color. Then, the reference values are combined. Thereby, patch data which identifies a plurality of the patches is created. Then, half tone processing is performed on the patch data, and a plurality of the patches are printed. The correspondence definition data is created based on color measuring data obtained by subjecting a plurality of the printed patches to color measuring.

In the correspondence definition data, gradation values corresponding to the ink quantities are defined similarly with the above-mentioned input gradation values. That is, this definition is made so that: a gradation value which is an integral value existing in a predetermined range of value and corresponds to a higher-lightness range will be reduced in variation in the ink recording rate corresponding to the unit variation in that gradation value as compared with gradation values corresponding to a lower-lightness range. When half tone processing is carried out, ink quantities corresponding to the reference values in the patch data are interpreted according to the definition of gradation values to create the half tone image data.

With this constitution, subtle variation in color can be faithfully reflected with respect to patches which specify colors at high lightness during print operation. The color measuring data obtained by subjecting these patches to color measuring accurately specifies colors also with respect to patches at high lightness. Therefore, based on this color measuring data, correspondence between the color component values of various colors used in the another image device and the gradation values corresponding to the ink quantities of inks in individual ink colors used in the printing device can be defined. Thus, correspondence definition data which allows accurate color conversion can be created.

Half tone processing only has to be capable of determining the presence or absence of ink dots according to the definition of gradation values and acquiring half tone image data which indicates the presence or absence of dots. More specific description will be given. Gradation values corresponding to a high-lightness range and gradation value corresponding to a low-lightness range are different from each other in variation in ink recording rate to the unit variation in gradation value. Ink recording rates denoted by the individual gradation values in this definition are interpreted, and the presence or absence of dots is determined so that that ink recording rate will be obtained. This half tone image data only has to specify the presence or absence of dots. In case a dot exists, a difference may be further provided in the size of the dot (the quantity of ink).

As mentioned above, variation in lightness to the unit variation in ink recording rate at high lightness is greater than variation in lightness to the unit variation in ink recording rate at low lightness. For this reason, with respect to ordinary inks, the lightness hardly varies in a predetermined lightness range containing the lowest lightness that can be represented in each ink color even if the ink recording rate is varied. Consequently, the predetermined lightness range containing the lowest lightness that can be represented in ink colors may be excluded when the above-mentioned gradation values corresponding to ink quantities are defined.

More specifically, all the gradation values are allocated to a part of the range of value of ink recording rate when the gradation values corresponding to ink quantities are defined. Thus, ink recording rates at which substantial variation in lightness cannot be represented on a printing medium can be excluded. Then, gradation values can be allocated only to ink quantities with which the lightness can substantially vary. Therefore, ink quantities can be effectively represented in levels with a limited capacity, and subtler variation in gradation can be represented.

The range of value of ink recording rate is defined with a state in which no ink is recorded on a printing medium taken as the minimum ink recording rate and a state in which inks are recorded on a printing medium to the maximum taken as the maximum ink recording rate. For simplicity's sake, a range of value common to all the ink colors may be adopted as a part of the range of value of ink recording rate. Or, in consideration of ink-by-ink difference in the rate of change in lightness, a different range of value may be adopted as the above-mentioned part of the range of value of ink recording rate with respect to each ink. This philosophy can be also applied to a tenth aspect of the present invention. That is, the total number of gradations may be allocated to a part of the range of value of ink recording rate when the input gradation values are defined.

In the present invention, correspondence definition data wherein the resolution in the high-lightness range is relatively higher than the resolution in the low-lightness range only has to be capable of being created. For this reason, correction may be carried out on the first gradation value data obtained by bringing the ink quantity and the magnitude of gradation values into substantially linear correspondence when correspondence definition data is created. That is, correction can be carried out with a higher rate of increase applied to gradation values corresponding to a high-lightness range than that for gradation values corresponding to a lower-lightness range. Thus, the number of gradations in ink value data corresponding to the unit variation in ink recording rate can be increased more in a higher-lightness range.

Further, γ correction may be carried out on the first gradation value data so that the smaller the gradation value is, the higher the rate of increase in correction will be. According to this correction, the smaller value the first gradation value data is, the more the number of gradations in ink value data after correction can be increased. With this constitution, the smaller ink value data indicates the higher lightness. The result of print operation with ink quantities defined by this ink value is subjected to color measuring to create correspondence definition data. Thus, correspondence definition data wherein the resolution in the high-lightness range is relatively higher than the resolution in the low-lightness range can be created.

In any case, the number of representable gradations is limited with a specific storage capacity. Therefore, the first gradation value data is subjected to correction to bring the magnitude of ink value data and the ink quantity into non-linear correspondence. Thus, it is possible to maintain a storage capacity required for representing gradations and further vary the relative resolution of ink value on a lightness range-by-lightness range basis. By incorporating this workings into correspondence definition data, accurate color conversion can be carried out in the high-lightness range.

If 256 shades of gray are rendered with 8 bits, each gradation value is an integral value, and the fractional portion thereof is dropped or rounded off. Therefore, it can be said that: representing the intervals of ink recording rate with more gradations with ink values in the high-lightness range by γ correction is equivalent to enhancing the resolution in the high-lightness range relative to that in the low-lightness range. Also, it can be said that: this method utilizes ink values different in sense from conventional ink quantity gradation values which represent gradations by equally dividing the entire range of value of ink recording rate.

The present invention is that this idea is applied when correspondence definition data is created. As a result, highly accurate color conversion can be carried out in the high-lightness range wherein the rate of change in lightness to variation in ink quantity is high. The correspondence definition data is data which defines the correspondence between ink values and the color component values of various colors used in the above-mentioned another image device. It includes table data which describes the correspondence between them with respect to a plurality of reference points, profile data which defines the relation between them by predetermined functions, and the like.

In any case, when correspondence definition data is created, a plurality of actually printed patches are subjected to color measuring. Then, correspondence with color component values used in another image device is established. As mentioned above, the ink quantities in patches subjected to color measuring are determined with ink values with enhanced resolution. More specific description will be given. Ink values which specify the ink quantities in a plurality of patches to be subjected to color measuring are ink values which are corrected with a higher rate of increase in the high-lightness range than that in the low-lightness range, similarly with the foregoing. Print operation is performed in accordance with these ink values.

When print operation is performed, usually, half tone processing is performed to determine a dot count per unit area. Therefore, in the half tone processing, the ink quantities denoted by the above-mentioned ink values with the enhanced resolution are interpreted to perform print operation. The thus printed patches are subjected to color measuring, and correspondence definition data is created. Then, referring to the correspondence definition data, color conversion is carried out, and the ink values after color conversion are subjected to the same half tone processing as mentioned above. Thus, accurate color conversion can be carried out. That is, by utilizing the system of ink values with enhanced resolution, colors in the high-lightness range can be rendered with accuracy. Further, by carrying out interpolation or the like referring to reference points wherein colors are specified with accuracy in the high-lightness range, accurate color conversion can be carried out.

Needless to add, if a plurality of pieces of ink value data which specify the ink quantity of each color ink and wherein the resolution in the high-lightness range is higher than the resolution in the low-lightness range are defined beforehand, that data may be acquired when print operation is performed. More specifically, in ink value data which specifies ink quantities to be subjected to color measuring, the resolution at high lightness only has to be enhanced. Half tone processing is performed with the fact that the resolution has been enhanced in the data taken into account when print operation is performed. Thus, correspondence definition data which allows accurate color conversion can be created.

Color measuring only has to be capable of acquiring the chromatic value of print results. It only has to be capable of obtaining color measuring data which indicates coordinates in a non-equipment-dependent color space, such as the Lab color space. When correspondence definition data is created, color measuring data which indicates coordinates in the non-equipment-dependent color space and coordinates in the non-equipment-dependent color space indicated by color data used in another image device can be used.

More specific description will be given. It is assumed that the coordinates of a plurality of colors in a non-equipment-dependent color space are known. In this case, the ink values of arbitrary colors and color data used in another image device can be calculated by interpolation or the like. Therefore, with respect to an arbitrary color, correspondence between them can be calculated to define correspondence definition data. With respect to color data used in another image device, coordinates in the non-equipment-dependent color space must be acquired. Therefore, the data is preferably data in conformity with the sRGB standard with which data coordinates in the non-equipment-dependent color space can be calculated by predetermined expressions. Needless to add, the display colors of the another image device may be subjected to color measuring.

When print operation is performed according to the present invention, it is only has to be possible to interpret ink quantities denoted by the ink values with enhanced resolution when half tone processing is performed. As a concrete constitution for this purpose, inverse correction and half tone processing wherein a deviation equivalent to the fractional portion obtained as the result of the inverse correction is reflected can be adopted. That is, inverse correction to the above-mentioned correction is carried out. As a result, the ink values after inverse correction are the same as in a state in which the ink recording rate of 0 to 100% is uniformly allocated to the gradations of 0 to 256, as mentioned above. Thus, the ink recording rate can be grasped from the individual gradation values to determine ink quantities.

However, the situation in which the resolution is high at high lightness is maintained. This is because a deviation equivalent to the fractional portion obtained when inverse correction is carried out is reflected during the half tone processing. Needless to add, a deviation equivalent to the fractional portion obtained when inverse correction is carried out cannot be indefinitely considered. However, colors can be determined with accuracy by considering the fractional portion to a predetermined digit according to the capability available in half tone processing. At this time, a deviation equivalent to the fractional portion obtained when inverse correction is carried out only has to be capable of being considered. Instead of such a constitution that inverse correction is actually carried out, other constitutions may be adopted. For example, values obtained by determining the ink recording rate corresponding to each piece of the corrected ink value data mentioned above to a higher number of bits may be stored beforehand.

Further, the present invention also functions as a print controller which carries out color conversion referring to the above-mentioned correspondence definition data and performs print operation. That is, by referring to this correspondence definition data, color conversion can be accurately carried out with respect to colors at high lightness during print operation. Then, tone jump can be prevented from occurring in the high-lightness range.

Further, it can be said that an apparatus which creates the above-mentioned correspondence definition data utilizes the technical philosophy of the present invention. A correspondence definition data creating apparatus in accordance with a 13th or 14th aspect of the present invention may be constituted according to a 19th or 20th aspect. Needless to add, constitutions in accordance with 15th to 18th aspects of the present invention are possible. Such a correspondence definition data creating apparatus may be solely implemented, or may be incorporated into some equipment and implemented together with another apparatus or method. Thus, the philosophy of the present invention is not limited to these aspects but can be implemented in various embodiments. The embodiments of the present invention can be modified as appropriate, and the prevent invention may be embodied in software or in hardware.

As a concrete example of embodiments of the philosophy of the present invention, it is assumed that it is embodied in software for implementing a method or an apparatus for creating color conversion tables. In such software as well, the present invention functions as such and is utilized. Therefore, the present invention can be implemented as a color conversion table creating program as in a ninth aspect thereof. In this case, constitutions in accordance with fourth to seventh aspects of the present invention are possible. Further, the present invention can be implemented as correspondence definition data creating program as in a 21st or 22nd aspect thereof. In this case, constitutions in accordance with 15th to 18th aspects thereof are possible. Needless to add, the recording medium may be a magnetic recording medium or a magneto-optic recording medium, and this is the same with any recording medium that will be developed in the future. Also, this is completely the same with the phases of reproduction, such as primary duplicate copies and secondary duplicate copies, completely without question.

Even if a communication line is used as a method for supply, there is no difference in that the present invention is utilized. If the present invention is embodied partly in software and partly in hardware, that is completely the same in the philosophy of invention. Such an embodiment that part of the program is stored on a recording medium and read in as required may be adopted. Or, all the functions need not necessarily be implemented in the program itself, but some functions may be implemented by an external program or the like. This is because even in this case, every function only has to be capable of being implemented by a computer.

### BRIEF DESCRIPTION OF THE DRAWINGS

FIG. 1 is an explanatory drawing schematically illustrating the process of the generating method for color conversion table.

FIG. 2 is a drawing illustrating the relation between the recording rate (%) of ink droplets and the lightness L thereof.

FIG. 3 is an explanatory drawing illustrating how the pitch of variation in reference point is reduced.

FIG. 4 is a flow chart illustrating the process of color conversion table generation.

FIG. 5 is a block diagram of a computer.

FIG. 6 is a drawing illustrating an example of variation in value which occurs when γ correction is carried out.

FIG. 7 is an explanatory drawing illustrating half tone processing.

FIG. 8 is a block diagram of a computer which uses LUT when print operation is performed.

FIG. 9 is an explanatory drawing illustrating how color conversion is carried out.

FIG. 10 is an explanatory drawing illustrating how tone jump is reduced.

FIG. 11 is an explanatory drawing illustrating an example of how to exclude part of high ink recording rate.

FIG. 12 is an explanatory drawing illustrating correction wherein part of high ink recording rate is excluded.

FIG. 13 is an explanatory drawing schematically illustrating the process of color conversion table generation.

FIG. 14 is a flowchart illustrating the process of color conversion table generation.

FIG. 15 is a block diagram illustrating the constitution of a color conversion table generator.

FIG. 16 is a drawing illustrating an example of variation in value which occurs when color separation and γ correction are carried out.

FIG. 17 is an explanatory drawing illustrating half tone processing.

### DESCRIPTION OF THE PREFERRED EMBODIMENTS

Here, embodiments of the present invention will be described in the following order:

A. First Embodiment

(1) General Description of Color Conversion Table Generation:

(2) Apparatus and Processing for Color Conversion Table Generation:

(3) Print Operation Utilizing LUT Generated According to The Present Invention:

(4) Modifications:

(1) General Description of Color Conversion Table Generation:

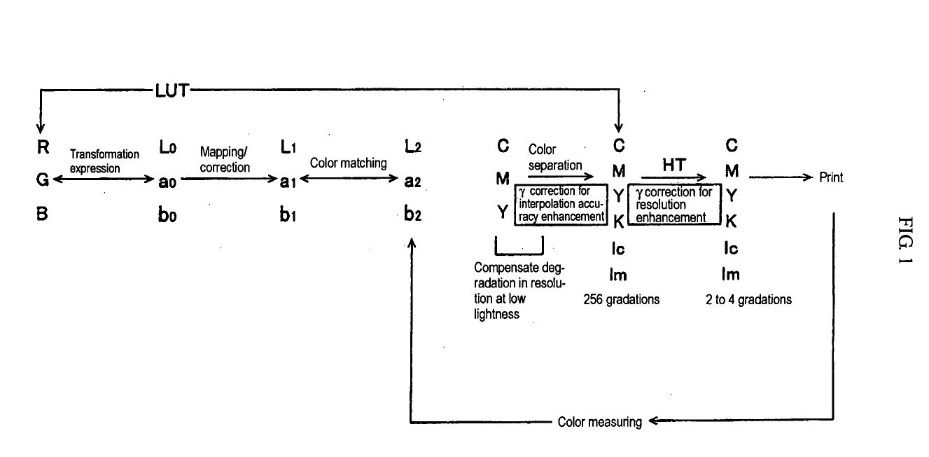

FIG. 1 is an explanatory drawing schematically illustrating the process of color conversion table generation according to the present invention. Major part of this process requires computation, and a computer is preferably used. Since print operation is actually performed, it is preferable that a printer which utilizes generated color conversion tables to perform print operation should be used in printing. Half tone processing (HT) described later is required to use the same algorithm as used in half tone processing in that printer.

The color conversion table in this embodiment is a table which defines correspondence between RGB data and CMYKlclm data with respect to 17³ reference points. By referring to these reference points in interpolation, the RGB data and the CMYKlclm data can be brought into correspondence with each other with respect to arbitrary colors. In this embodiment, the RGB data is data in conformity with the sRGB standard used in displays for computer. It renders colors by combinations of RGB colors rendered with gradations in 256 levels (data which specifies the gradations of each color by integral values of 0 to 255) with respect each color. The CMYKlclm data is data for specifying discharged ink quantities in the printer in this embodiment. Each color has 256 gradations (data which specifies the gradations of each color by integral values of 0 to 255), and colors are rendered by combinations of the colors.

To perform print operation with the printer, the color conversion table is required to bring the RGB data and the CMYKlclm data into correspondence with each other. The CMYKlclm data relates to equipment-dependent colors specific to individual printers. Therefore, when a color conversion table is generated, usually, the result of print operation actually performed with the printer is subjected to color measuring. Then, by bringing the RGB data and the CMYKlclm data into correspondence with each other in a non-equipment-dependent color space, a color conversion table is generated.

In this embodiment, as this non-equipment-dependent color space, the Lab color space is adopted. (Usually, this space is represented as L*a*b*. In this specification, however, * is omitted for simplicity's sake. This is the same with the following description.) In the process of generating a color conversion table, coordinate values in the Lab color space are determined with respect to both the RGB data and the CMYKlclm data, first of all. The RGB data is in conformity with the sRGB standard as mentioned above. Therefore, the sRGB data can be transformed into coordinate value in the Lab color space by predetermined transformation expressions. In FIG. 1, the coordinates after transformation is represented as L₀a₀b₀, and in this stage, a plurality of pieces of RGB data are transformed into coordinate values in the Lab color space.

Color conversion is carried out with respect to arbitrary colors rendered by RGB data and CMYKlclm data. To enable this color conversion, it is preferable that the above-mentioned reference points should be distributed substantially over the whole color gamut of display and printer in the color conversion table. However, in general, the color gamut of display and the color gamut of printer are different from each other. To cope with this, color gamut mapping is carried out to convert colors in a display into colors which can be rendered in a printer. When image output is produced, such colors as flesh color and sky blue often look like of higher image quality by converting them into colors close to humans' memorized colors than by directly outputting actual colors. Therefore, with respect to this type of color, actual colors are converted into memorized colors. In FIG. 1, the coordinates in the Lab color space obtained by transforming the coordinates L₀a₀b₀ as mentioned above is represented as L₁a₁b₁. A plurality of pieces of the RGB data are brought into correspondence with L₁a₁b₁.

Meanwhile, the CMYKlclm data is ink value data which specifies ink quantities and relates to equipment-dependent colors. Therefore, coordinate values in the Lab color space are acquired by subjecting actually printed patches to color measuring with a color measuring instrument. However, the CMYKlclm data is data with which arbitrary colors are rendered by combining the ink quantities of six color inks as appropriate. Therefore, very similar colors can be rendered by a large number of combinations.

In this embodiment, 10³ patches are subjected to color measuring. However, there are a large number of colors which are different in coordinates in the ink quantity space but very similar to one another. If combinations of ink quantities to be subjected to color measuring without any rule to go by, the colors are distributed substantially over the whole color gamut of the printer. Further, it is difficult to select a favorable combination of six colors when an arbitrary color is converted. To cope with this, in general, color separation wherein virtual CMY values are transformed into six color ink quantities is carried out. In this embodiment as well, the concept of color separation is utilized.

In color separation, each of three colors of CMY is rendered in 256 shades of gray, and a three-dimensional space with the individual colors taken on orthogonal axes (virtual CMY space) is supposed. Coordinate values which indicate colors to be subjected to color measuring are determined in the virtual CMY space. Further, the coordinate values are transformed into six-dimensional ink values by a predetermined transformation expression. More specific description will be given. It is easy to formulate a transformation expression for transforming coordinate values in the three-dimensional space into coordinate values in the six-dimensional space. Therefore, 10³ objects of color measuring are determined in the three-dimensional virtual CMY space. Then, transformation from three dimensions to six dimensions is carried out by this transformation expression to determine CMYKlclm data.

In this color separation, transformation is carried out so that ink recording rates can be determined from CMYKlclm data after color separation. Most simply, transformation is carried out by uniformly allocating ink recording rates of 0 to 100% to the gradations of 0 to 255, so that ink recording rates can be determined from the individual ink values. Needless to add, color separation can be carried out by transformation expressions for carrying out transformation with various limitations taken into account. Such limitations include limitation on the maximum quantity of ink recorded on a printing medium and limitation on use of black ink. In any case, ink recording rates are determined from CMYKlclm data after color separation.

Once CMYKlclm data is determined as mentioned above, 10³ sets of coordinate values to be subjected to color measuring are obtained in the ink quantity space wherein each color is in 256 shades of gray. Patches indicated by these coordinate values are printed. In ink jet printers, gradations are represented in two to four levels with respect to each dot. Two gradations represent a state in which ink droplets are recorded and a state in which an ink droplet is not recorded. Four gradations represent a state in which an ink droplet is not recorded and states in which large, medium, and small dots are respectively recorded. Therefore, each color ink quantity in the 256 gradations is subjected to half tone processing to convert it into data which represents the gradation of each dot in the printer. When print operation is performed based on this data, 10³ patches are obtained. Therefore, these patches are subjected to color measuring with a color measuring instrument. As a result, coordinate values in the Lab color space can be determined with respect to the 10³ patches. In FIG. 1, these coordinate values are represented as L₂a₂b₂.

By the above-mentioned process, the coordinate value L₂a₂b₂ corresponding to the CMYKlclm data in 256 gradations and the coordinate value L₁aₗb₁ corresponding to the RGB data in 256 gradations can be determined. Based on these pieces of data, the correspondence between the RGB data and the CMYKlclm data is determined. The coordinate value L₂a₂b₂ and the coordinate value L₁a₁b₁ do not indicate the identical color. Since 10³ coordinate values exist in the color space, however, arbitrary CMYKlclm data can be calculated from the coordinate value L₂a₂b₂ by interpolation. Further, arbitrary RGB data can be calculated from the coordinate value L₁a₁b₁ by interpolation. Therefore, the correspondence between the RGB data and the CMYKlclm data can be defined by interpolation, and thus the above-mentioned color conversion table can be determined.

A color conversion table can be determined by the above-mentioned process. However, with this color conversion table, it used to be impossible to carry out color conversion without tone jump with respect to specific colors. More specifically, when the ink quantity is increases at a constant rate, in general, the lightness thereof does not fluctuate at a constant rate. Therefore, in the above-mentioned color separation, it used to be impossible to define a color conversion table which appropriately corresponds to this variation in lightness due to fluctuation in ink quantity.

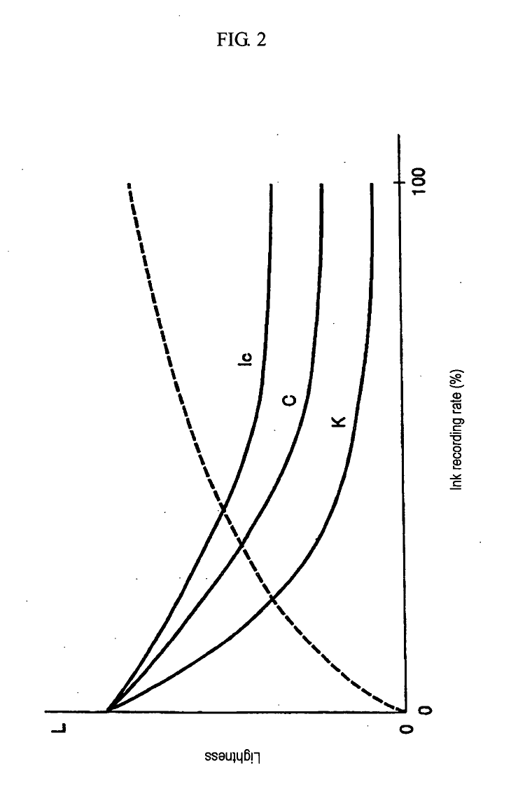

FIG. 2 is a drawing illustrating the relation between the recording rate (%) of ink droplets recorded per unit area with respect to each color ink and the lightness L thereof. As a concrete example, the relation is shown with respect of each of K, C, and lc inks. As illustrated in the figure, variation in lightness to variation in ink recording rate is not constant. With respect to all the colors, the curves are convex downward. That is, in the high lightness range where ink droplets are small in number, the lightness largely varies with increase in the number of ink droplets. In the lower lightness range, variation in lightness becomes duller with increase in the number of ink droplets.

Further, the deeper the colors of the inks themselves become, the more the rate of change in lightness is likely to lower with the ink recording rate in the low lightness range. Further, a color conversion table does not define the correspondence between the RGB data and the CMYKlclm data with respect to all the gradation values. But it defines the correspondence between them with respect to a plurality of reference points, as mentioned above. The interpolation accuracy of CMYKlclm data varies from one value to another in the CMYKlclm data.

That is, the interpolation accuracy of CMYKlclm data can be said to be higher with increase in the degree of matching between colors printed with CMYKlclm data obtained by interpolation and colors corresponding to RGB data before transformation. With poor interpolation accuracy, tone jump can occur. For example, if reference points are substantially uniformly set in the whole range of value of each color ink quantity, the interpolation accuracy in the high-lightness range where each color ink quantity is small is inferior to the interpolation accuracy in the low-lightness range where each color ink quantity is large. This is because: in this case, variation in lightness to variation in recording rate is not linear between reference points corresponding to high lightness. Further, the absolute value of lightness also largely fluctuates. Therefore, as light difference in ink quantity is actually represented as large variation in lightness.

If virtual CMY values are transformed into ink values by a standardized transformation expression as in the above-mentioned color separation, it is difficult to cope with characteristics with respect to each value of ink quantity. Therefore, according to the present invention, CMYKlclm data is subjected to γ correction for the enhancement of resolution after or during color separation. Then, colors are described with accuracy by reference points corresponding to CMYKlclm data which indicates high lightness. More specifically, γ correction is carried out with an input/output characteristic curve, as plotted by a broken line in FIG. 2, which is convex upward and shows characteristics inverse to the characteristics of the inks. (The curve is that which resembles the broken lines plotted in FIG. 2 if, when an input value of ink quantity gradation value is transformed into a predetermined output value, the range of value of ink recording rate and the range of input value are matched with each other and the range of lightness value and the range of output value are matched with each other.) When half tone processing is carried out with respect to CMYKlclm data after this γ correction for resolution enhancement, γ interpretation (inverse γ correction) described later is carried out. Then, values equivalent to the fractional portions in the system of numeric values before γ correction for resolution enhancement are also taken into account. Thereby, print operation with high resolution can be performed.

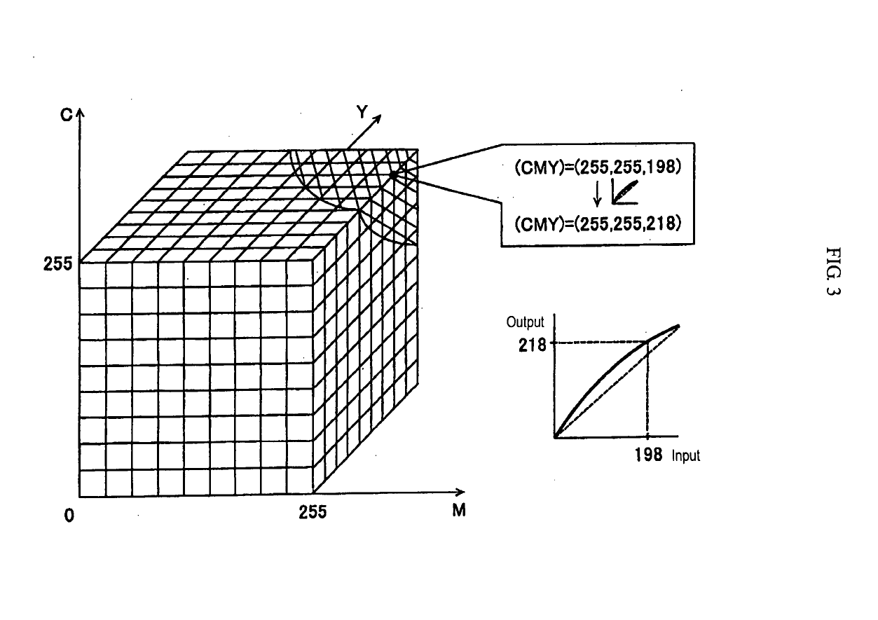

It is colors in the high-lightness range that enables print operation with high resolution by γ correction for resolution enhancement, as mentioned above. With respect to colors in the low-lightness range, the resolution is relatively degraded. To compensate this degradation, CMYKlclm data which gives low lightness is made larger in the number of reference points than CMYKlclm data which gives high lightness. That is, with reference points corresponding to CMYKlclm data which gives low lightness, interpolation can be carried out utilizing reference points whose values are close to each other. Thus, the interpolation accuracy is enhanced. FIG. 3 is an explanatory drawing illustrating how CMYKlclm data which gives low lightness is made larger in the number of reference points than CMYKlclm data which gives high lightness. This figure is a schematic diagram illustrating 10³ objects of color measuring in the virtual CMY space. The cube shown in the figure represents the virtual CMY space with each of CMY colors taken on an axis. The presence of reference points is indicated by the lattice points in the cube.

The gradation value of each of CMY colors is equally divided into nine, and 10 gradation values are supposed with respect to each color. Further, if gradation values of the individual colors are arbitrarily combined, the lattice points in the cube illustrated in the figure become reference points. In the present invention, the gradation value of each color is subjected to γ correction for interpolation accuracy enhancement. Thereby, variation in value between before and after correction is made greater for higher gradation values (equivalent to low lightness). As a result, a higher gradation value is shifted to a larger value. For example, it is assumed that with respect to a reference point, a combination of CMY colors before γ correction for interpolation accuracy enhancement is (255,255,198). By γ correction for interpolation accuracy enhancement, the values becomes (255,255,218).

In this embodiment, γ correction for interpolation accuracy enhancement is carried out by a curve convex upward, as illustrated at the lower right of the figure, in a graph with input values taken on horizontal axis and output values taken on vertical axis. In this curve, the input gradation value 198 is transformed into the gradation value 218. Therefore, combinations of CMY colors are converted as described above. Thus, by carrying out γ correction for interpolation accuracy enhancement with respect to each color, colors at low lightness can be increased in number. In the present invention, color measuring patches are printed with respect to colors specified by CMYKlclm data obtained by γ correction for interpolation accuracy enhancement. Therefore, when a color conversion table is generated using the result of this color measuring, colors in the low-lightness range can be defined with accuracy.

Therefore, when color conversion is carried out by the resulting color conversion table, colors in the low-lightness range can be converted with accuracy. Thus, the interpolation accuracy at low lightness can be enhanced. This γ correction for interpolation accuracy enhancement may be carried out before color separation or during color separation. As mentioned above, in this embodiment, by utilizing γ correction for resolution enhancement and γ correction for interpolation accuracy enhancement, the resolution is enhanced in the high-lightness range and the interpolation accuracy is enhanced in the low-lightness range. Needless to add, the interpolation accuracy can be enhanced by utilizing ink value data wherein the number of colors at low lightness is increased by utilizing only γ correction for interpolation accuracy enhancement, as well.

(2) Apparatus and Processing for Color Conversion Table Generation:

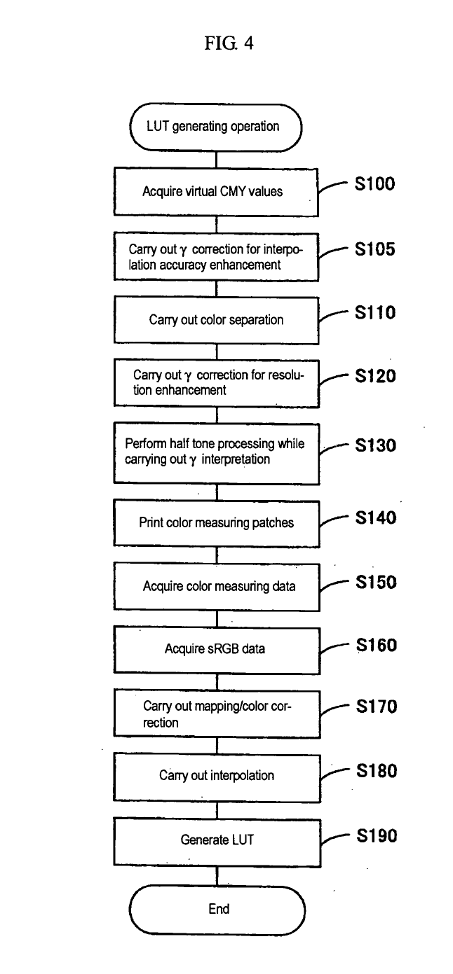

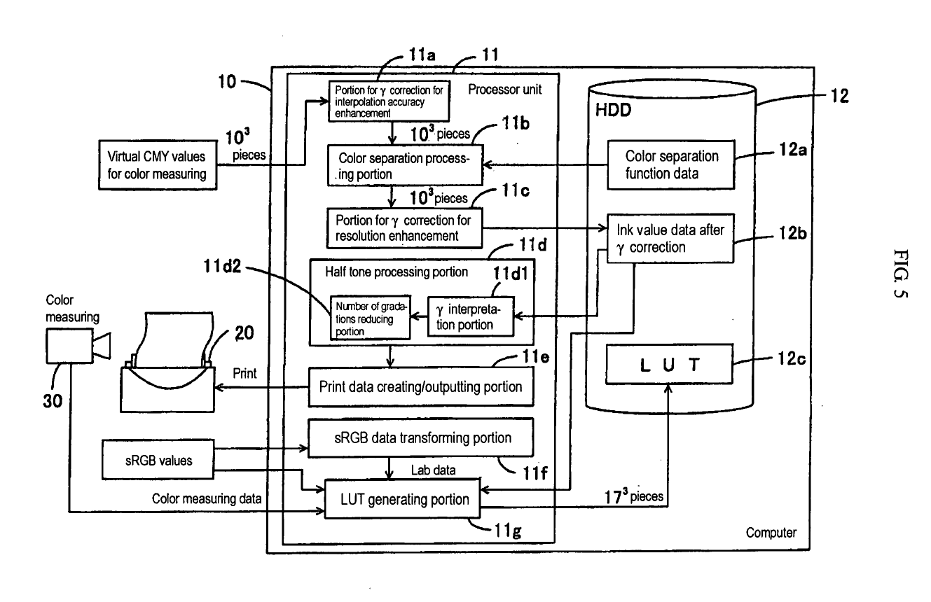

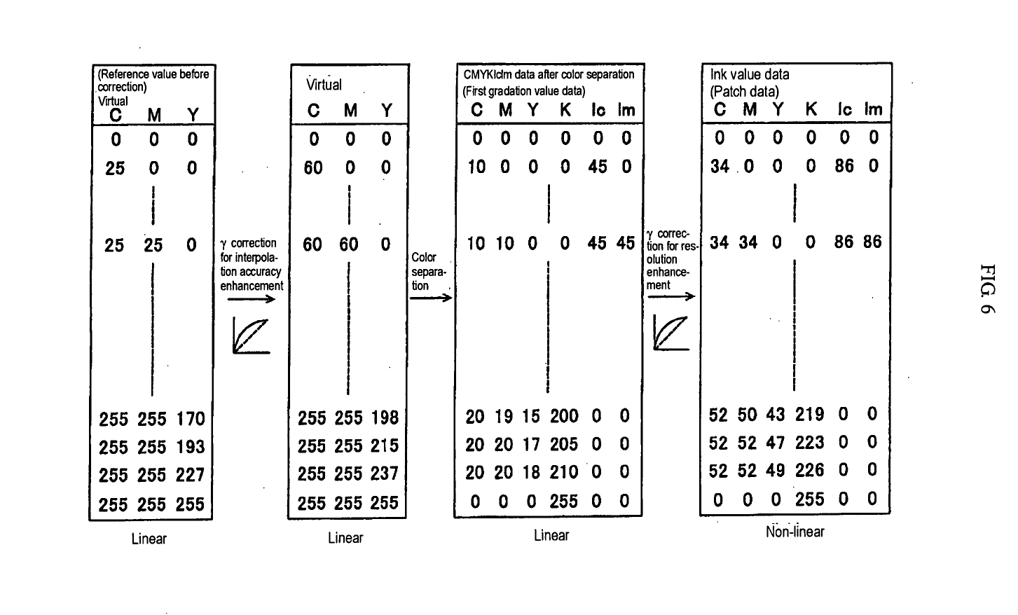

According to the present invention, the occurrence of tone jump is reduced by γ correction for interpolation accuracy enhancement and γ correction for resolution enhancement. An apparatus and processing for this purpose will be specifically described below. FIG. 4 is a flowchart illustrating the process of generating a color conversion table (LUT) according to the present invention. FIG. 5 is a block diagram illustrating the constitution of a computer for executing the processing. FIG. 6 is a drawing illustrating an example of variation in value which occurs when virtual CMY values are subjected to γ correction for interpolation accuracy enhancement and CMYKlclm data is subjected to color separation and further to γ correction for resolution enhancement.

The computer 10 comprises a processor unit 11 which executes computation and HDD 12 which stores data. The computer 10 is connected with a printer 20 through an interface (not shown), and print operation is performed by outputting print data from the computer 10.

Further, the computer 10 is capable of acquiring color measuring data obtained from color measuring by a color measuring instrument 30. With respect to input of this color measuring data, various embodiments can be adopted. For example, the data can be inputted by a predetermined input device, inputted through a recording medium, or inputted by data transfer by connection through the predetermined interface.

The processor unit 11 is capable of executing predetermined programs for generating color conversion tables and executing computation. A color separation processing portion 11b acquires 10³ virtual CMY values for color measuring at Step 100. In this embodiment, the virtual CMY values for color measuring correspond to the values of lattice points uniformly disposed in the virtual CMY space. More specifically, the virtual CMY values for color measuring, indicated on the extreme left of FIG. 6, are values obtained by arbitrarily combining gradation values obtained by substantially equally dividing the gradation value range of each color into nine. The gradation value range of virtual CMY is between 0 and 255 inclusive, and gradation values are defined by integers. If inks in three CMY colors are supposed, the ink quantities thereof are considered to be in linear correspondence with gradation values.

Virtual CMY values for color measuring are inputted to a portion 11a for γ correction for interpolation accuracy enhancement. At Step 105, γ correction for interpolation accuracy enhancement is carried out. As mentioned above, this γ correction for interpolation accuracy enhancement is carried out by an input/output characteristic curve convex upward with respect to each color. As shown in the second table from the left of FIG. 6, the rate of increase between before and after correction is higher when the CMY values are small than when the values are large. (For example, while the values of C of 0 to 25 become 0 to 60, the values of Y of 170 to 193 become 198 to 215.) Further, the magnitude of the gradation values after correction and the ink quantity are considered to be in linear correspondence with each other. Therefore, colors at low lightness are increased in number after the γ correction for interpolation accuracy enhancement, as compared with combinations of gradation values obtained by equally dividing the gradation value range.

The virtual CMY values which were subjected to γ correction for interpolation accuracy enhancement at Step 105 are inputted to the color separation processing portion 11b, and subjected to color separation there. The color separation is carried out by substituting the virtual CMY values after the γ correction for interpolation accuracy enhancement into a predetermined color separation function. This color separation function is defined by color separation function data 12a stored in the HDD 12. Needless to add, color separation may be carried out by interpolation utilizing LUT, instead of substitution into the function.

In color separation, colors before and after color separation are matched, though not strictly, with each other. The values of CMYKlclm data after color separation are integral values of 0 to 255. Further, the magnitude of values of CMYKlclm data after color separation and the ink quantity are considered to be in linear correspondence with each other. As a result, the CMYKlclm data after color separation also indicates the same colors as after the above-mentioned γ correction for interpolation accuracy enhancement. Thus, colors at low lightness are increased in number, as compared with the virtual CMY values (reference value before correction) indicated on the extreme left of FIG. 6. Therefore, by subjecting the result of printing this CMYKlclm data to color measuring and carrying out interpolation, reference points closer to each other in low-lightness colors than in high-lightness colors can be utilized in the interpolation. Thus, a color conversion table which enables accurate color conversion at low lightness can be generated. If γ correction for interpolation accuracy enhancement is carried out after color separation, the gradation values in CMYKlclm data after color separation correspond to the gradation values before correction related to the above-mentioned aspect. Combinations of extracted gradation values correspond to the reference values before correction.

When the color separation processing portion 11b creates CMYKlclm data by color separation, a portion 11c for γ correction for resolution enhancement carries out γ correction for resolution enhancement at Step 120. This γ correction is carried out on the CMYKlclm data using the characteristic curve as illustrated by a broken line in FIG. 2 with respect to each color. That is, the γ correction is carried out by an input/output characteristic curve convex upward. Therefore, as shown on the extreme right of FIG. 6, a smaller value than other gradation values is corrected with a higher rate of increase.

With respect to the gradation values after this γ correction for resolution enhancement, the magnitude thereof and the ink quantity are not in linear correspondence with each other. Gradation values are defined so that: a gradation value corresponding to a higher-lightness range will be less reduced in ink recording rate corresponding to the unit variation in that gradation value as compared with gradation values in a lower-lightness range. More specific description will be given. In this embodiment, CMYKlclm data after color separation is in linear correspondence with ink recording rates. However, data after γ correction for resolution enhancement is different in the meaning of values, and is in non-linear correspondence with ink recording rates. As a result, the smaller a gradation value is, the more fractional portion can be reflected when half tone processing is performed, as described later. Thus, the accuracy of color conversion is enhanced. The ink value data 12b after γ correction, obtained as the result of γ correction by the portion 11c for γ correction for resolution enhancement, is stored in the HDD 12.

The minimum value and maximum value of input values are not different between before and after the γ correction for interpolation accuracy enhancement or γ correction for resolution enhancement. Further, output values are integers. Therefore, values after γ correction are also integers, and the range of the values is between 0 and 255 inclusive. Since values after correction are integers, in the result of integerization, a smaller value in CMYKlclm data after color separation does not necessarily more greatly vary between before and after γ correction. However, at least in the stage of γ correction, the correction is carried out so that a smaller value will more greatly vary between before and after γ correction. Both data shown in the second table from the right of FIG. 6 and data shown on the extreme right are data with respect to each ink color of CMYKlclm. Therefore, in this specification, the former is referred to as “CMYKlclm data after color separation,” and the latter is referred to as “ink value data” for the purpose of discrimination.

In this embodiment, in the CMYKlclm data after color separation, the magnitude of gradation values and the ink quantity are in substantially linear correspondence with each other. Therefore, the data corresponds to the first gradation value data described in connection with the above aspect. In this case, the color space constituted of virtual CMY corresponds to the predetermined color space constituted of a smaller number of color components than the above-mentioned number of ink colors. The ink value data is values inputted to a half tone processing portion 11d, and it specifies patches to be subjected to color measuring. Therefore, the data is patch data in the above-mentioned aspect. It is not indispensable to carry out color separation. Accordingly, only data after color separation does not correspond to the first gradation value data. Other data can be the first gradation value data if the magnitude of gradation values and the ink quantity is in substantially linear correspondence with each other. For example, if color separation is not carried out, the virtual CMY after γ correction for interpolation accuracy enhancement corresponds to the first gradation value data.

The half tone processing portion 11d performs half tone processing at Step 130. In the half tone processing, the discharged ink droplets in the printer 20 are specified based on the ink quantities of inks in CMYKlclm colors after γ correction for resolution enhancement. The half tone processing portion 11d comprises a γ interpretation portion 11d1 and a number of gradations reducing portion 11d2. The γ interpretation portion 11d1 is capable of calculating values in the ink value data 12b which has not been subjected to γ correction for resolution enhancement yet. The number of gradations reducing portion 11d2 performs half tone processing based on the values before γ correction for resolution enhancement. The portion 11d2 then creates intermediate data which specifies discharged ink droplets with respect to each pixel in the printer 20. However, in this half tone processing, even values which would correspond to frictional portions before γ correction are grasped from the values after γ correction for resolution enhancement. Then, differences in the fractional portions are reflected when the half tone processing is performed.

More specific description will be given. In half tone processing, to represent gradations by adjusting the count of dots recorded per unit area, discharged inks are specified with respect to each pixel in the printer 20. If CMYKlclm colors are rendered with 256 gradations, variation in dot count corresponding to variation by one step of gradations is not 1 but one step-variation in gradation results in a large number of steps in dot variation. Therefore, in half tone processing, subtle variation which is fundamentally equivalent to the above-mentioned fractional portion can be represented. If data equivalent to the fractional portion is provided, colors can be outputted with higher accuracy.

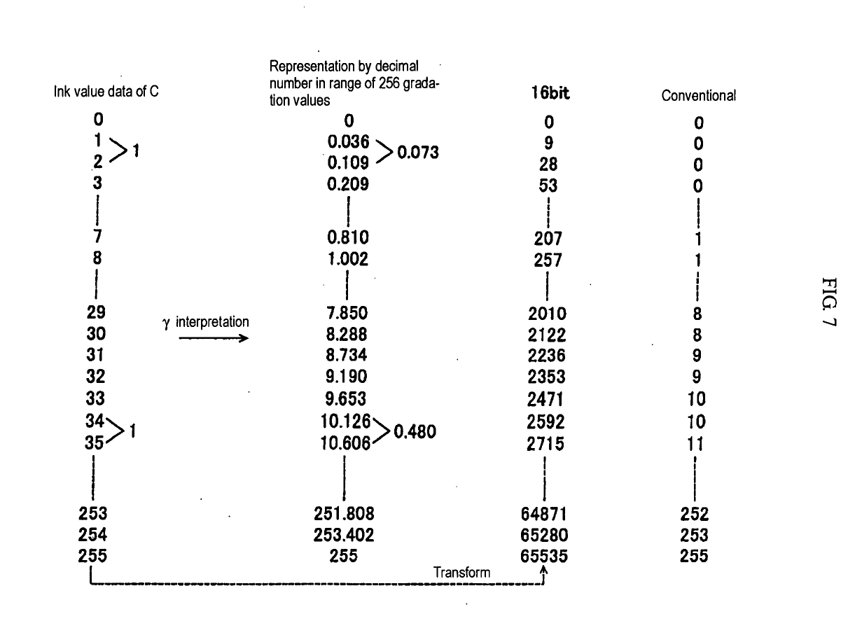

FIG. 7 is an explanatory drawing illustrating this half tone processing. On the extreme left of the figure, ink value data of C ink is shown as an example. On the left of the center of the figure, data after interpretation by they interpretation portion 11d1 is shown. In this embodiment, the values containing a fractional portion shown in this column can be calculated by subjecting the ink value data of C ink to inverse γ correction which has input/output characteristics inverse to that of the γ correction for resolution enhancement. This inverse γ correction is so designed that when an input value is transformed into a predetermined output value, the minimum value and maximum value of the input value will not vary.

Therefore, the range of values after inverse γ correction is also between 0 to 255 inclusive. In this embodiment, the magnitude of the count of dots recorded per unit area is represented by the magnitude of values after inverse γ correction. The value 0 represents 0% of ink recording rate, and the value 255 represents 100% of ink recording rate. Then the value 1 represents 100×1/255% of ink recording rate. As shown on the left of the center of FIG. 7, seven values ranging from 0.036 to 0.0810 exist under a value of 1.002. Therefore, differences in ink recording rate of 100×1/255% or less can be reflected when half tone processing is carried out.

As illustrated in FIG. 7, the smaller a value in ink value data is, the smaller the variation in ink recording rate to the unit variation in that ink value data is (that is, variation by “1” in ink value data). For example, if the ink value data varies from “1” to “2,” the corresponding ink recording rate varies from “0.036” to “0.109,” and the variation is “0.073.” If the ink value data varies from “34” to “35,” the corresponding ink recording rate varies from “10.126” to “10.606,” and the variation is “0.480.” The variation in the former ink recording rate is smaller.

For this reason, it can be said that with the ink value data in this embodiment, subtler variation in ink recording rate can be represented in the high-lightness range where the ink recording rate is low. Also, it can be said that the resolution of ink value data is high in the high-lightness range. If CMYKlclm data after color separation is subjected to γ correction for resolution enhancement and γ interpretation is not carried out during half tone processing, as in the present invention, all the fractional portions, as shown on the left of the center of FIG. 7, are rounded off by half adjust or the like. On this account, subtle variation in ink recording rate cannot be rendered in the high-lightness range. For example, ink recording rates not more than 100×1/255% can be represented only as 0, as shown on the extreme right of FIG. 7. Therefore, correspondence which enables accurate color conversion in the high-lightness range cannot be defined.

Data corresponding to the fractional portions after inverse γ correction may be directly handled as fractional portions, as shown on the left of the center of FIG. 7. Needless to add, they may be handled after being transformed into integral values. For example, data may be transformed into gradation values described with a capacity of 16 bits, as shown under 16 bits on the right of the center of FIG. 7. More specifically, ink value data many be transformed into 16-bit data during γ interpretation so that ink recording rates will be represented by numeric values in 65535 gradations. In this case, there is no difference in that a deviation equivalent to the fractional portions obtained when inverse γ correction is carried out similarly with the foregoing is reflected when half tone processing is performed.

To transform ink value data into 16-bit data, various constitutions can be adopted. For example, a table wherein ink value data and 16-bit data after transformation are in correspondence with each other may be generated beforehand, and this table may be referred to. In any case, in the number of gradations reducing portion 11d2 of the half tone processing portion 11d, values containing the above-mentioned fractional portions or values defined with 16 bits can be adopted as a threshold for determining whether to discharge dots or not. Thus, a deviation equivalent to the fractional portions can be reflected when half tone processing is performed.

By carrying out color conversion referring to a color conversion table generated according to the present invention which is provided with the above-mentioned mechanism, tone jump can be prevented from occurring in all the lightness ranges. More specific description will be given. Virtual CMY values are subjected to γ correction for interpolation accuracy enhancement. Thereby, it is made possible to calculate CMYKlclm data corresponding to low lightness by interpolation from ink value data close to the value thereof. Further, the interpolation accuracy is enhanced. Here, it only has to be possible to enhance the interpolation accuracy so as to compensate the resolution at low lightness which is relatively degraded by γ correction for resolution enhancement. Further, CMYKlclm data is subjected to γ correction for resolution enhancement, and values after γ correction for resolution enhancement is subjected to color conversion. Thereby, even values equivalent to the fractional portions can be taken into account when half tone processing is carried out. Further, the resolution is enhanced when colors at high lightness are rendered. By both of the above-mentioned procedures, the accuracy of color conversion is enhanced.

A print data creating/outputting portion 11e performs such processing as arranging the data after half tone processing in the order of ink droplet discharge in the nozzles of the printer 20. Thereby, the portion 11e creates print data for printing patches corresponding to CMYKlclm data and outputs the data to the printer 20. As a result, the printer 20 prints 103 color measuring patches (Step 140).

After being printed, the color measuring patches are subjected to color measuring with the color measuring instrument 30 (Step 150). The color measuring instrument 30 is an instrument which acquires Lab coordinate values to be subjected to color measuring as color measuring data. The acquired color measuring data is taken into the LUT generating portion 11g of the computer 10.

By the above-mentioned processing, coordinate values (equivalent to L₂a₂b₂ in FIG. 1) in the Lab color space as a non-equipment-dependent color space are obtained with respect to CMYKlclm data corresponding to the virtual CMY values for color measuring. At Step 160 and the following steps, processing is performed for acquiring coordinate values in the Lab color space corresponding to RGB data. Steps 160 and 170 maybe carried out before Step 100.

At Step 160, an sRGB data transforming portion 11f acquires previously prepared sRGB values, and transforms them into coordinate values (equivalent to L₀a₀b₀ in FIG. 1) in the Lab color space by a predetermined transformation expression. The number of values to be transformed by the sRGB data transforming portion 11f is 10³ or so. Values to be transformed can be specified beforehand, for example, by arbitrarily combining coordinates obtained by equally dividing the range of value of each of RGB colors into nine. At Step 170, the sRGB data transforming portion 11f further carries out the above-mentioned color gamut mapping and correction with memorized colors and the like taken into account. As a result, coordinate values equivalent to L₁a₁b₁ in FIG. 1 are obtained.

The coordinate values are taken into the LUT generating portion 11g. At Step 170 and the above-mentioned Step 150, the LUT generating portion 11g acquired L₁a₁b₁ and L₂a₂b₂ shown in FIG. 1. At Step 180, the correspondence between the RGB data and the CMYKlclm data is defined by interpolation with respect to a plurality of reference points.

Here, it only has to be possible to define the correspondence between the RGB data and the CMYKlclm data. RGB data and CMYKlclm data corresponding to arbitrary coordinates in the Lab color space can be calculated by interpolation. Therefore, the correspondence between the RGB data and the CMYKlclm data can be defined through the Lab coordinate values with respect to arbitrary colors. At Step 190, the RGB data and the CMYKlclm data are brought into correspondence with each other with respect to 17³ reference points. Then, table data which indicates this correspondence is created, and the created data is stored in the HDD 12 (LUT 12c).

(3) Print Operation Utilizing LUT Generated According to The Present Invention:

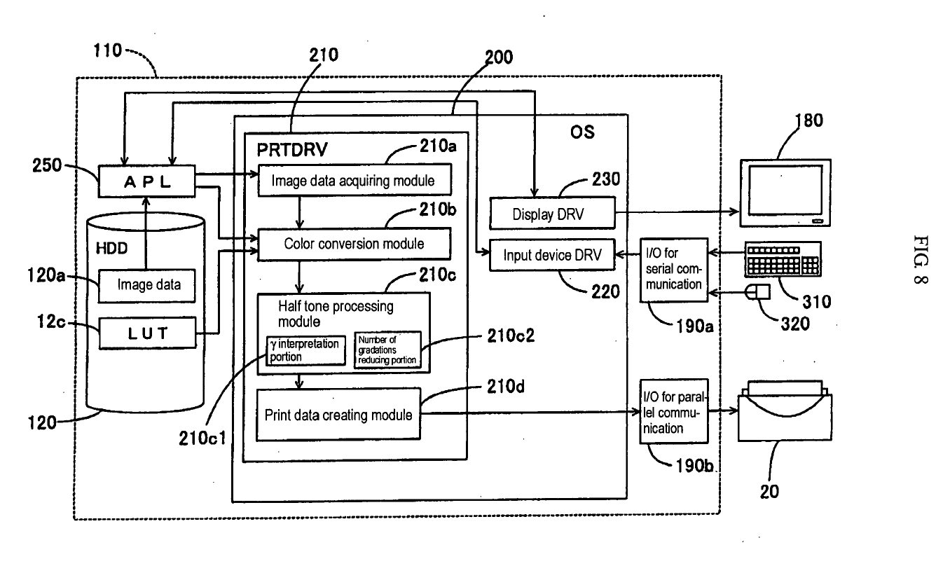

This LUT 12c is referred to for carrying out color conversion when print operation is performed with the printer 20. A constitution for performing this print operation will be described below. FIG. 8 is a block diagram illustrating an example of the constitution of a computer which uses the LUT 12c when print operation is performed. The computer 110 is a general-purpose personal computer, and a printer driver (PRTDRV) 210, an input device driver (DRV) 220, and a display driver (DRV) 230 are built in OS 200. The display DRV 230 is a driver which controls display of image data and the like on a display 180. The input device DRV 220 is a driver which receives code signals inputted from a keyboard 310 or a mouse 320 through I/O 190a for serial communication and accepts predetermined input operation.

APL 250 is application programs which are capable of executing retouching of color images and other functions. When an appropriate APL 250 is running, a user can operate the input devices to print color images with the printer 20. When such an color image is printed, LUT 12c generated according to the present invention is referred to. The color image data 120a of color images generated by the APL 250 is dot matrix data wherein RGB color components are represented with gradations. It is data in conformity with the sRGB standard, and is stored in the HDD 120.

To perform print operation, the PRTDRV 210 comprises an image data acquiring module 210a, a color conversion module 210b, a half tone processing module 210c, and a print data creating module 210d. LUTs 12c generated according to the present invention are stored in the HDD 120. If a user gives an instruction to perform print operation while the APL 250 is running, image data 120a required for the print operation is acquired by the image data acquiring module 210a. The image data acquiring module 210a actuates the color conversion module 210b. The color conversion module 210b is a module for converting RGB data into CMYKlclm data, and it uses reference points in LUT 12c to convert arbitrary RGB data into CMYKlclm data.

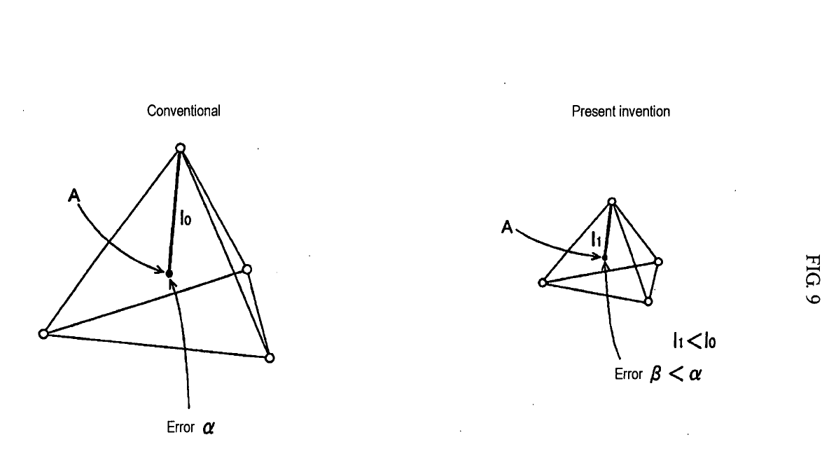

The CMYKlclm data is obtained by subjecting virtual CMY values to γ correction and color separation. Accordingly, LUT 12c is generated in such a situation that colors in the low-lightness range can be converted with high accuracy. Therefore, the correspondence between the RGB data and the CMYKlclm data defined in LUT 12c is also very accurate, and color conversion can be carried out with accuracy. FIG. 9 is an explanatory drawing illustrating how color conversion is accurately carried out in the low-lightness range. The figure illustrates how CMYKlclm data corresponding to arbitrary Lab values is calculated by interpolation. Interpolation in a conventional process of color conversion table generation is shown on the left, and interpolation according to the present invention is shown on the right. Position A represents a position to be interpolated in the Lab color space.

There are various techniques for interpolation. The figure illustrates a technique wherein four reference points close to position A are extracted, and the coordinate components at the individual reference points are weighted according to the distances between the reference points and position A and added to obtain the coordinates of position A. According to the present invention, colors in the low-lightness range are dense, as mentioned above. Therefore, it can be possible to extract four reference points closer to position A than in conventional situations wherein γ correction for interpolation accuracy enhancement is not carried out, when interpolation is carried out. That is, distance 1₁<distance 1₀.

Usually, the coordinate values of position A obtained by interpolation contains an error. Letting an error in conventional techniques and an error in the present invention be α and β, respectively, β<α because distance 1₁<distance 1₀ as mentioned above. Therefore, according to the present invention, the coordinates in the Lab color space and CMYKlclm data can be accurately brought into correspondence with each other in the low-lightness range. As a result, when LUT 12c is generated, the RGB data and the CMYKlclm data can be accurately brought into correspondence with each other. Since both are in correspondence with each other with accuracy, arbitrary RGB data can be accurately brought into correspondence with CMYKlclm data to the contrary when color conversion is carried out using LUT 12c. Thus, color conversion can be carried out with accuracy.

When the color conversion module 210b carries out color conversion and creates CMYKlclm data, the gradation data of CMYKlclm is passed to the half tone processing module 210c. The half tone processing module 210c is a module which performs the same processing as the half tone processing portion 11d does. The module 210c comprises a γ interpretation portion 210c1 and a number of gradations reducing portion 210c2. Therefore, when the CMYKlclm data is passed to the half tone processing module 210, the γ interpretation portion 210c1 calculates values in the ink value data which has not been subjected to γ correction for resolution enhancement yet. Then, the number of gradations reducing portion 210c2 performs half tone processing, taking the values equivalent to the fractional portions thereof into account.

As a result, whether to discharge inks at the individual nozzles can be determined with variation in lightness to variation in ink recording rate in CMYKlclm colors taken into account. The print data creating module 210d receives the data after half tone processing and rasterizes and rearranges it in the order of use in the printer 20. After this rasterization, the module 210d creates print data with required information, such as the resolution of the image, added thereto, and outputs the data to the printer 20 through an I/O 190b for parallel communication. Based on the print data, the printer 20 prints the image shown on the display 180.

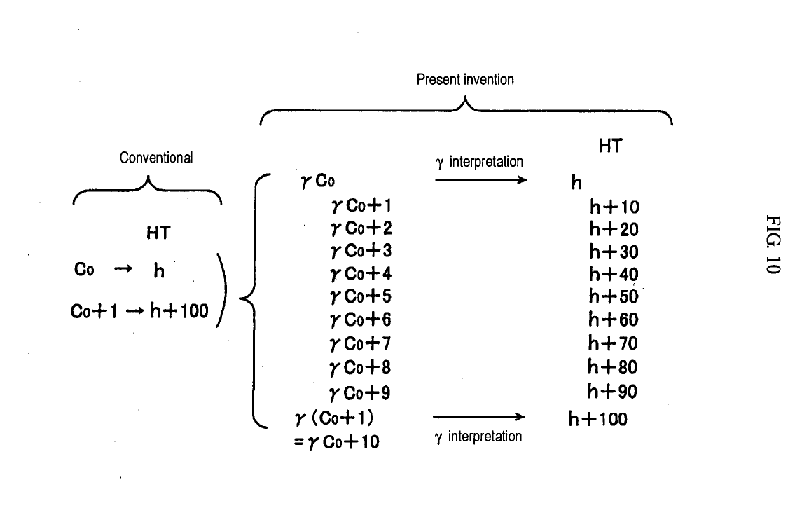

In this print operation, color conversion is carried out referring to LUT generated according to the present invention. Therefore, color conversion can be carried out with accuracy over the whole color gamut of the display 180 and the printer 20. Thus, print operation is performed with high image quality without tone jump. Referring to FIG. 10, how tone jump is reduced will be described below. On the left side of FIG. 10, an example of conventional half tone processing is shown. In this example, whether to discharge ink droplets at each pixel is determined so that the gradation value C₀ in ink value data will be made equal to dot count h per unit area by half tone processing (HT). A the same time, whether to discharge ink droplets at each pixel is determined so that the gradation value (C₀+1) will be made equal to dot count h+100 per unit area by half tone processing.

In conventional processing wherein γ correction for resolution enhancement is not carried out, the difference in gradation value in ink value data is just “1” even if there is a difference of “100” in the dot count after half tone processing. Though ink value data corresponding to an arbitrary color is obtained by interpolation referring to LUT, the number of gradations in each color handled by the computer is 256. A difference smaller than a gradation value of “1” in ink value data cannot be represented unless the volume of data is varied. Therefore, in conventional half tone processing, the minimum pitch of dot count is “100.”

On the right side of FIG. 10, an example of half tone processing according to the present invention is shown. In this example, data wherein gradation value C₀ has been subjected to γ correction for resolution enhancement is represented as γC₀. Data wherein gradation value (C₀+1) has been subjected to γ correction is represented as γ(C₀+1). The γ correction is a technique for correcting input values and output values by γ curve. In a graph with input values taken on horizontal axis and output values taken on vertical axis, a straight line with a gradient of ½ which passes through the origin point indicates a state in which correction is not carried out. At Step 120, correction is carried out by a γ curve which is convex upward in this graph and wherein input/output values do not fluctuate at the origin point and the maximum gradation value. Therefore, a smaller gradation value is corrected with a higher rate of increase.

In the example illustrated in FIG. 10, γ(C₀+1) is equal to γC₀+10. That is, nine levels of gradation (γC₀+1 to γC₀+9) exist between gradation value γC₀ and gradation value γ(C₀+1). Therefore, if interpolation is carried out referring to LUT 12c wherein reference points are defined with data which has been subjected to γ correction for resolution enhancement, not only gradation values γC₀ and γC₀+10 can be represented. Also, values between them can be represented.

The half tone processing module 210c grasps values before γ correction at Step 120 by γ interpretation and performs half tone processing. Processing can be performed so that γC₀ will result in dot count h and γ(C₀+1) will result in dot count h+100. At the same time, processing can be performed so that gradation values γC₀+1 to γC₀+9 between them will result in dot counts h+10 to h+90. That is, the minimum pitch of dot count is remarkably reduced. According to the present invention, correction is carried out so that the smaller a gradation value is, the larger the original value will be, by a γ curve convex upward, as mentioned above. Therefore, the pitch of variation in dot count after half tone processing is not strictly constant, as illustrated in FIG. 10. However, there is no difference in that subtle variation in color can be represented with respect to colors wherein the coefficient of fluctuation in lightness to ink recording rate is high when half tone processing is performed. Therefore, tone jump can be reduced.

(4) Modifications:

The above-mentioned embodiment is an example. Various constitutions can be adopted as long as the following conditions are satisfied: it should be possible to make the resolution in the high-lightness range relatively higher than the resolution in the low-lightness range. At the same time, it should be possible to increase the number of colors in the low-lightness range so as to compensate the resolution at low lightness which is relatively degraded as a result, by interpolation accuracy. The applicants experimentally carried out γ correction for resolution enhancement by combining gradation values uniformly distributed in the above-mentioned virtual CMY space (and carrying out color separation as required) The applicants further carried out γ correction for interpolation accuracy enhancement on gradation values uniformly distributed in the virtual CMY space. It has been revealed from the result of the experiments that color conversion can be carried out with accuracy in all the lightness ranges in the latter case.

In consideration only of the enhancement of interpolation accuracy in the low-lightness range, only colors in the low-lightness range may be increased in number as required, without taking into account the values equivalent to the fractional portions of gradation values as mentioned above. Needless to add, the lightness range wherein the colors are to be increased in number is not limited to the low-lightness range. Further, since the colors of patches to be subjected color measuring only have to biasedly exist in a specific lightness range, various techniques as well as γ correction can be adopted to apply a bias.

Further, with an algorithm wherein correction can be carried out by the same γ curve with respect to all the colors of virtual CMY values, γ correction can be carried out by very simple calculation. Needless to add, however, different γ curves may be used for different colors. Further, the γ curve may be changed depending on printing medium or print mode. In theses cases, a different color conversion table is generated with respect to each γ curve.

In the above-mentioned embodiment, data obtained by carrying out color separation is subjected to γ correction for interpolation accuracy enhancement. However, it is not indispensable to utilize data which underwent color separation. In the present invention, it only has to be possible to increase the number of colors in a specific lightness range and thereby enhance the color conversion accuracy. Therefore, objects of color measuring obtained by a technique other than color separation maybe subjected to γ correction to acquire the first gradation value data.

The number of gradation levels obtained after the γ correction for resolution enhancement is not limited to nine levels, illustrated in FIG. 10. More specific description will be given. When the accuracy is enhanced in the high-lightness range, the number of gradation levels which can be represented is reduced in the low-lightness range. Accordingly, γ correction for resolution enhancement can be carried out so that the most convenient situation will be obtained in terms of the balance between them. In reality, color conversion can be carried out with high accuracy even with such a constitution that the resolution in the high-lightness range is enhanced to three times or so at the maximum as compared with conventional cases by γ correction for resolution enhancement. More specifically, color conversion can be carried out with high accuracy even by correcting a gradation value of “1” in CMYKlclm data to a gradation value of “3.”

In the above-mentioned embodiment, γ correction for resolution enhancement is carried out so that ink value data can be brought into correspondence with the whole range of value of ink recording rate. However, as illustrated in FIG. 2, the lightness does not largely vary to variation in ink recording rate if the ink recording rate is high. That is, lightness gradations with substantial variation cannot be represented within a predetermined range of value of recording rate containing the maximum ink recording rate. Consequently, to utilize part of the range of value of ink recording rate, part of high ink recording rates corresponding to low lightness may be excluded from CMYKlclm data after color separation which is to be subjected to γ correction for resolution enhancement.

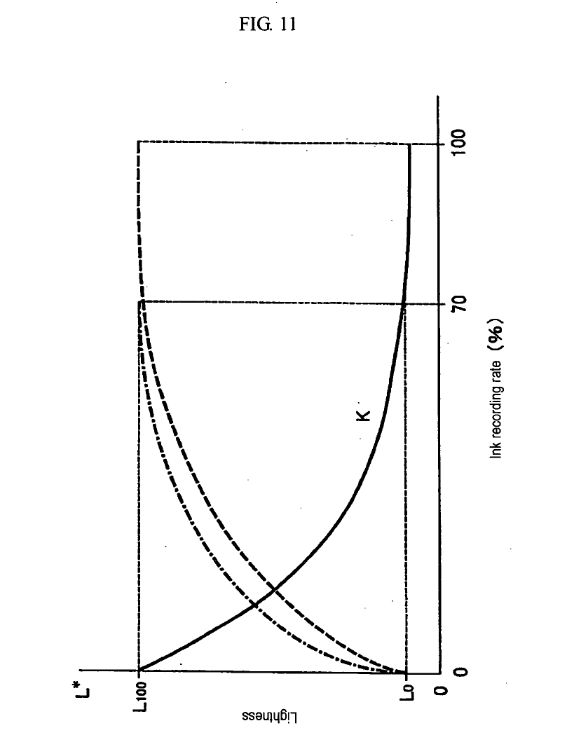

FIG. 11 is an explanatory drawing illustrating an example of how to exclude part of high ink recording rates corresponding to low lightness from CMYKlclm data after color separation. The curve plotted in a solid line in the figure indicates the relation of lightness to ink recording rate with respect to K ink. In this K ink, the lightness hardly varies in the range of value of ink recording rate of 70% to 100%. Consequently, CMYKlclm data after color separation corresponding to ink recording rates of 0% to 100% is not transformed into ink value data by γ correction for resolution enhancement as in the above-mentioned embodiment, indicated by a broken line in the figure. Instead, the CMYKlclm data (gradation value: 0 to 179) corresponding to ink recording rates of 0% to 70% is transformed into 256-gradation ink value data by γ correction for resolution enhancement, as shown by an alternate long and short dash line in the figure.

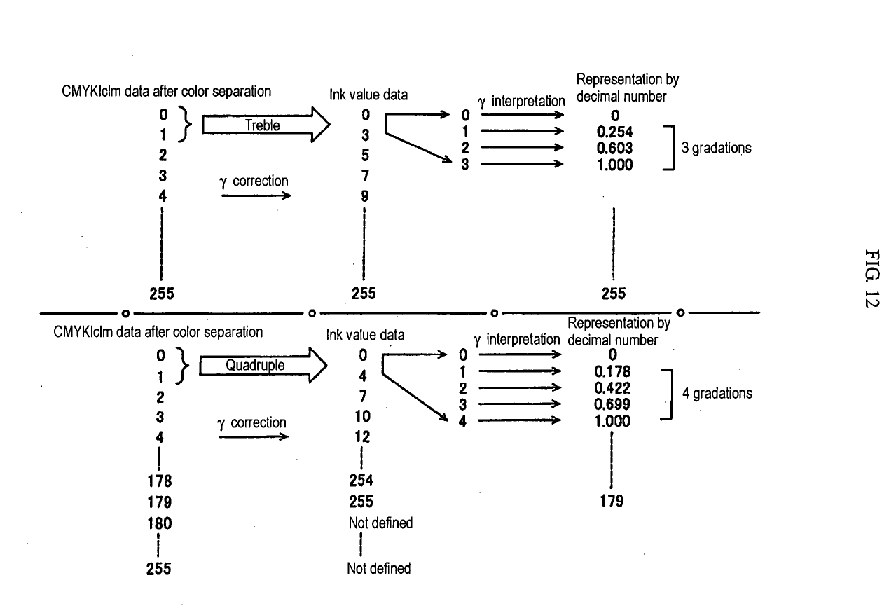

FIG. 12 is an explanatory drawing illustrating the former and latter embodiments. In the upper half of the figure, an example wherein the resolution of gradation values of “0” to “1” is transformed and trebled by γ correction for resolution enhancement is shown. In the lower half, an example wherein the range of value of ink recording rate is limited to 0% to 70% is shown. In the example shown in the upper half of the figure, CMYKlclm data after color separation is integral values of 0 to 255. This is corrected so that the smaller a value is, the larger the rate of increase in correction will be, as mentioned above, and the obtained result is integerized. Thus, the ink value data shown in the upper half of the figure is obtained.

More specifically, “0” and “1” in CMYKlclm data after color separation are transformed into “0” and “3” in ink value data, respectively. When the above-mentioned patch or color image is printed based on this ink value data, γ interpretation is carried by the half tone processing module. This γ interpretation is correction whose characteristics are inverse to those of the above γ correction for resolution enhancement. “0,” “1,” “2,” and “3” in ink value data are transformed into “0,” “0.254,” “0.603,” and “1.000,” respectively. Therefore, gradations can be represented in three levels with respect to ink recording rates in C data after color separation, which are equivalent to a value greater than “0” and not more than “1.”

Meanwhile, C data after color separation defined by integral values of 0 to 255, shown in the lower half of FIG. 12, is subjected to γ correction for resolution enhancement. For this γ correction, the ranges of input/output gradation values are made different from those for the γ correction for resolution enhancement shown in the upper half of FIG. 12. More specifically, in a situation in which the values in C data after color separation of 0 to 255 are in linear correspondence with ink recording rates of 0% to 100%, the values in C data after color separation of 0 to 179 are taken as input. Then, the gradation values in ink value data are made to be 0 to 255. Further, the γ value (equivalent to exponent in γ correction for resolution enhancement) is made equal to that in the γ correction for resolution enhancement shown in the upper half of the FIG. 12.

As the result of this γ correction for resolution enhancement, “0” and “1” in C data after color separation are transformed into “0” and “4” in ink value data, respectively. Further, in the example shown in the lower half of FIG. 12, when γ interpretation is carried out by the half tone processing module, as well, correction whose characteristics are inverse to those of γ correction for resolution enhancement. As a result, “0,” “1,” “2,” “3,” and “4” in ink value data are transformed into “0,” “0.178,” “0.422,” “0.699,” and “1.000,” respectively. Therefore, ink recording rates in C data after color separation, which are equivalent to a value greater than “0” and not more than “1” can be represented with four-level gradations.

The maximum value in ink value data of 255 is interpreted as “179” in γ interpretation. As mentioned above, however, the lightness of prints hardly produces substantial variation even if an ink recording rate greater than 70% which is equivalent to the value “179” as mentioned above. Therefore, printing operation can be performed with sufficiently rich gradations even if half tone image data is created with the maximum value of “179.” In FIG. 12, with K ink, the lightness substantially varies at an ink recording rate of 0% to 70%, and thus 70% to 100% is excluded. Needles to add, this value does not limited to 70%, and may be varied depending on the properties of inks and gradations required on the high lightness side or low lightness side.

B. Second Embodiment

Here, description will be given with a focus on differences from the first embodiment mentioned above. Therefore, the same components as in the first embodiment are marked with the same reference numbers.

(1) General Description of Color Conversion Table Generation:

(2) Apparatus and Processing for Color Conversion Table Generation:

(3) Print Operation Utilizing LUT Generated According to The Present Invention:

(4) Modifications:

(1) General Description of Color Conversion Table Generation:

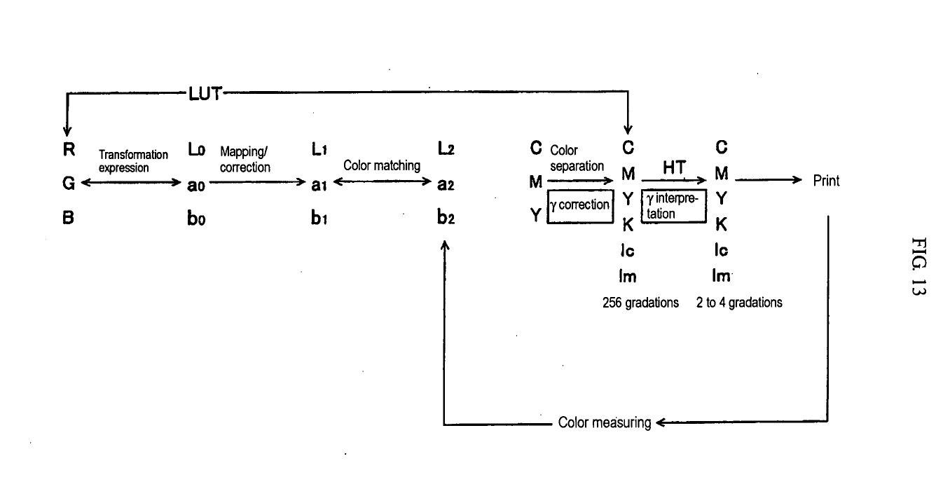

FIG. 13 is an explanatory drawing schematically illustrating the process of color conversion table generation according to the present invention.

This embodiment is different from the first embodiment in the processes of γ correction in color separation and γ interpretation in half tone processing. In this color separation, transformation is carried out so that ink recording rates can be determined from ink values after color separation.

If virtual CMY values are transformed into ink values using a standardized transformation expression by color separation, it is difficult to cope with characteristics with respect to each value of ink quantity. Therefore, according to the present invention, the CMYKlclm data is subjected to γ correction after or during color separation. Thereby, the interpolation accuracy at reference points corresponding to CMYKlclm data which gives low ink recording rates is enhanced. More specifically, γ correction is carried out with an input/output characteristic curve, as plotted by a broken line in FIG. 2, which is convex upward and shows characteristics inverse to the characteristics of the inks. As a result, values equivalent to fractional portions can be taken into account when half tone processing is performed. In this γ correction, the effect of reducing tone jump is sufficiently produced if the same curve is utilized for all the colors. However, a different correction curve equivalent to a curve corresponding to the curve of ink characteristics may be utilized for each color. In the above-mentioned half tone processing, after accurate interpolation is carried out by the γ correction, correction is carried out using a curve of inverse characteristics.

(2) Apparatus and Processing for Color Conversion Table Generation:

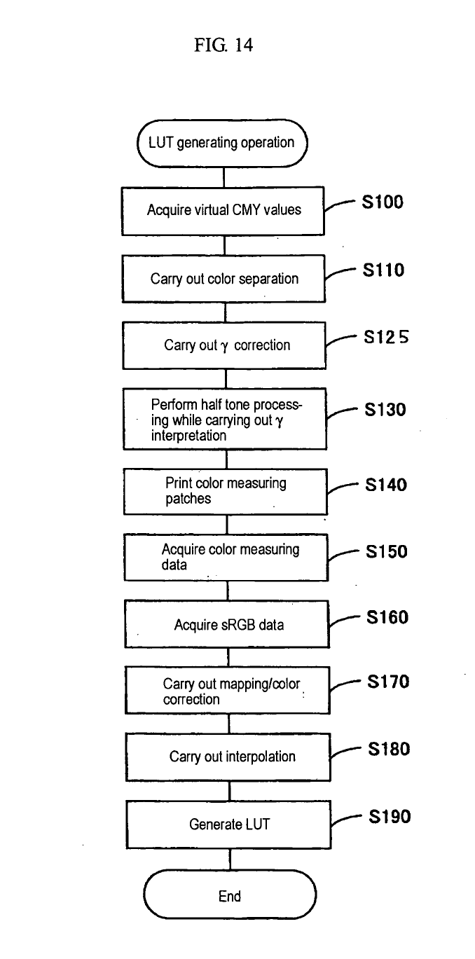

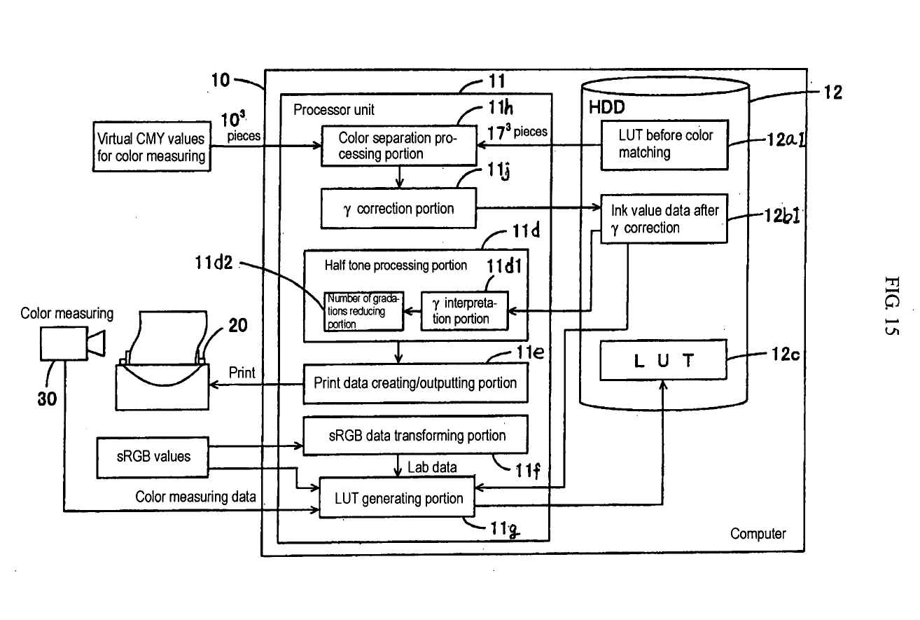

As mentioned above, according to the present invention, the occurrence of tone jump is reduced by carrying out γ correction in color separation. An apparatus and processing for this purpose will be specifically described below. FIG. 14 is a flowchart illustrating the process of generating a color conversion table (LUT) according to the present invention. FIG. 15 is a block diagram illustrating the constitution of a computer for executing the processing. In FIG. 15, portions which are the same as or equivalent to the corresponding portions in the first embodiment are marked with the same reference numbers.

The processor unit 11 of the computer 10 is capable of executing predetermined programs for generating color conversion tables and executing computation. A color separation processing portion 11h acquires 10³ virtual CMY values for color measuring at Step 100. At Step 110, the color separation processing portion 11h refers to LUT 12al before color matching stored in HDD 12 and further creates CMYKlclm data corresponding to the virtual CMY values.

More specific description will be given. The LUT 12al before color matching is data obtained by transforming virtual CMY values into CMYKlclm data by the transformation expression for the color separation with respect to 17³ reference points and tabulating the obtained result. By subjecting arbitrary virtual CMY values to color separation using this LUT 12al before color matching, corresponding CMYKlclm data can be obtained. This embodiment adopts such a constitution that virtual CMY values are transformed into CMYKlclm data by LUT 12al before color matching. Here, it only has to be possible to carry out color separation. Needless to add, therefore, various constitutions can be adopted. For example, a matrix computing equation may be stored, and based on the computing equation, virtual CMY values may be transformed into CMYKlclm data.

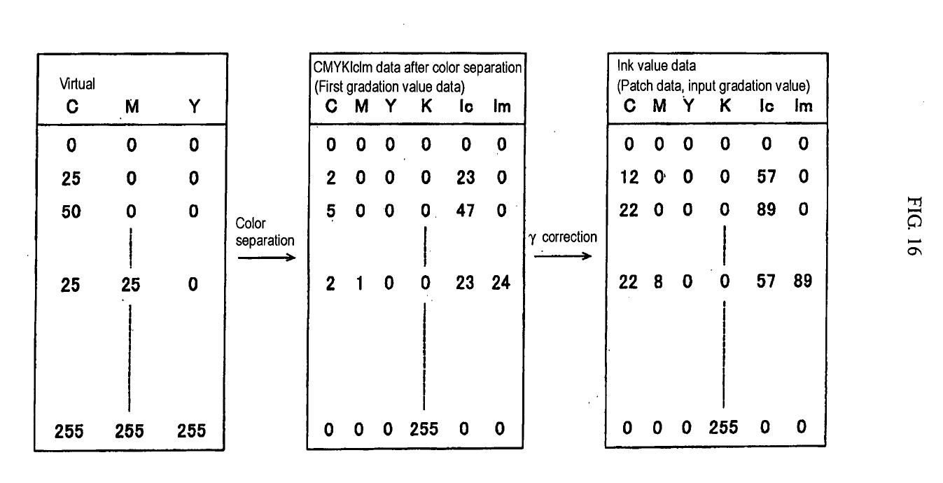

When the color separation processing portion 11h creates CMYKlclm data by color separation, a γ correction portion 11j carries out γ correction on the CMYKlclm data at Step 125. In this γ correction, a characteristic curve indicated by a broken line in FIG. 2 is used. FIG. 16 is a drawing illustrating an example of variation in value which occurs when virtual CMY values are transformed into CMYKlclm data by color separation and further γ correction is carried out. On the left of the figure, 10³ coordinates obtained by arbitrarily combining values obtained by substantially equally dividing the gradation value range of each color of virtual CMY into nine are shown as an example. In the center of the figure, CMYKlclm data after color separation obtained by subjecting these virtual CMY values to color separation is shown as an example.

On the right of the figure, data obtained by subjecting the CMYKlclm data after color separation to γ correction is shown. This γ correction is correction by a characteristic curve which is convex upward when input values are taken on horizontal axis and output values are taken on vertical axis and whose characteristics are inverse to the characteristics of inks. Further, the γ correction is such correction that the smaller a value in CMYKlclm data after color separation is, the larger variation in value between before and after γ correction is. The minimum value and maximum value of input values are not different between before and after γ correction, and output values are integers. Therefore, values after γ correction are also integers, and the range of the values is between 0 and 255 inclusive. Since values after correction are integers, as the result of integerization, a smaller value in CMYKlclm data after color separation does not necessarily more greatly vary between before and after γ correction. However, at least in the stage of γ correction, the correction is carried out so that a smaller value in CMYKlclm data will more greatly vary between before and after γ correction.

The values in the CMYKlclm data after color separation are also integers, and the range of the values is between 0 and 255 inclusive. In CMYKlclm data after color separation, the magnitude of values therein and the ink quantity are in linear correspondence with each other. However, with respect to ink value data after γ correction, a smaller gradation value (value corresponding to high lightness) is corrected with a higher rate of increase. Therefore, the magnitude of ink values and the ink quantity is in non-linear correspondence with each other. More specific description will be given. In this embodiment, CMYKlclm data after color separation is in linear correspondence with ink recording rates. However, ink value data is different in the meaning of values, and is in non-linear correspondence with ink recording rates. Both data shown in the center and data shown on the right of FIG. 16 are data with respect to each ink color of CMYKlclm. Therefore, in the following description, the former is referred to as “CMYKlclm data after color separation,” and the latter is referred to as “ink value data” for the purpose of discrimination.

Ink value data 12b1 after γ correction, obtained as the result of γ correction by they correction portion 11j, is stored in HDD 12. The half tone processing portion 11d performs half tone processing at Step 130. In the half tone processing, the discharged ink droplets in the printer 20 are specified based on the ink quantities of inks in CMYKlclm colors after the γ correction.

In this half tone processing, subtle variation corresponding to the fractional portions can be represented by nature. With data corresponding to fractional portions provided, colors can be outputted with higher accuracy. By carrying out color conversion referring to a color conversion table generated according to the present invention which is provided with the above-mentioned mechanism, tone jump can be prevented from occurring, as described later.

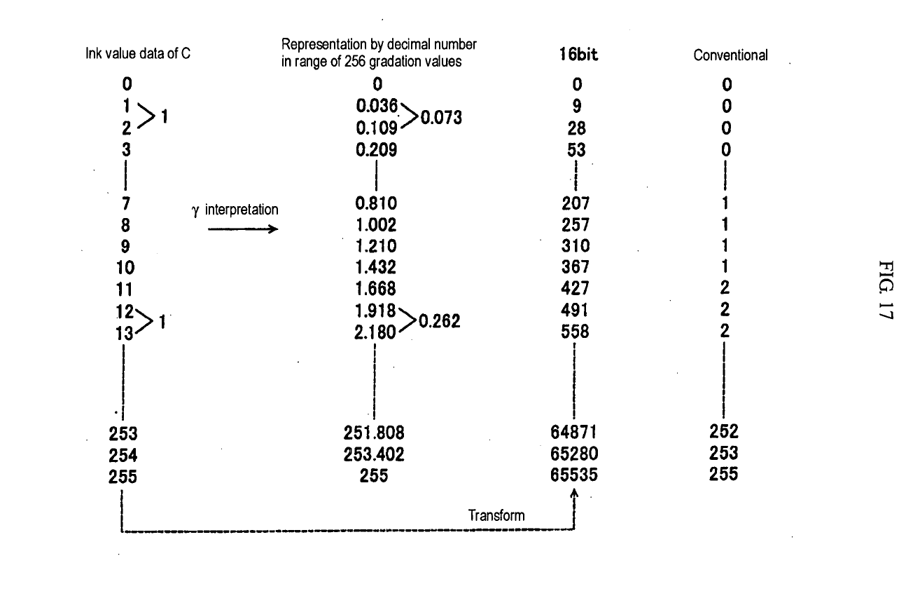

FIG. 17 is an explanatory drawing illustrating this half tone processing. As illustrated in the figure, the smaller a value in ink value data is, the smaller variation in ink recording rate to the unit variation in that ink value data is. For example, if the ink value data varies from “1” to “2,” the corresponding ink recording rate varies from “0.036” to “0.109,” and the variation is “0.073.” If the ink value data varies from “12” to “13,” the corresponding ink recording rate varies from “1.918” to “2.180,” and the variation is “0.262.” The variation in the former ink recording rate is smaller.

The print data creating/outputting portion 11e performs such processing as arranging the data after half tone processing in the order of ink droplet discharge in the nozzles in the printer 20. Thereby, the portion 11e creates print data for printing patches corresponding to the ink value data 12b1 and outputs the data to the printer 20. As a result, the printer 20 prints 10³ color measuring patches (Step 140).

After being printed, the color measuring patches are subjected to color measuring with the color measuring instrument 30 (Step 150).

By the above-mentioned processing, coordinate values (equivalent to L₂a₂b₂ in FIG. 13) in the Lab color space as a non-equipment-dependent color space are obtained with respect to CMYKlclm data (ink value data) obtained after virtual CMY values for color measuring are subjected to color separation and γ correction.

At Step 160, the sRGB data transforming portion 11f acquires previously prepared sRGB values, and transforms them into coordinate values (equivalent to L₀a₀b₀ in FIG. 13) in the Lab color space by a predetermined transformation expression. At Step 170, the sRGB data transforming portion 11f further carries out the above-mentioned color gamut mapping and correction with memorized colors and the like taken into account. As a result, coordinate values equivalent to L₁a₁b₁ in FIG. 13 are obtained.

The coordinate values are taken into the LUT generating portion 11g. At Step 170 and Step 150, the LUT generating portion 11g acquired L₁a₁b₁ and L₂a₂b₂ shown in FIG. 13. At Step 180, the correspondence between the RGB data and the CMYKlclm data after γ correction is defined by interpolation with respect to a plurality of reference points.

Here, the correspondence between the RGB data and the CMYKlclm data after γ correction only has to be defined. RGB data corresponding to arbitrary coordinates in the Lab color space and CMYKlclm data after γ correction corresponding to arbitrary coordinates in the Lab color space can be calculated by interpolation. Therefore, the correspondence between the RGB data and the CMYKlclm data after γ correction can be defined through the Lab coordinate values with respect to arbitrary colors. At Step 190, the RGB data and the CMYKlclm data after γ correction are brought into correspondence with each other with respect to 17³ reference points. Then, table data which indicates this correspondence is created, and the created data is stored in the HDD 12 (LUT 12c).

(3) Print Operation Utilizing LUT Generated According to The Present Invention:

When a user gives an instruction to perform print operation while APL 250 is running, image data 120a required for the print operation is acquired by the image data acquiring module 210a. The image data acquiring module 210a actuates the color conversion module 210b. The color conversion module 210b is a module for converting RGB data into CMYKlclm data, and it uses reference points in LUT 12c to convert arbitrary RGB data into CMYKlclm data. This CMYKlclm data is data which underwent the above-mentioned γ correction.

When the color conversion module 210b carries out color conversion and creates CMYKlclm data, the gradation data of CMYKlclm is passed to the half tone processing module 210c. When the CMYKlclm data is passed to the half tone processing module 210, the γ interpretation portion 210c1 calculates values in the CMYKlclm data which has not been subjected to γ correction yet. Then, the number of gradations reducing portion 210c2 performs half tone processing, taking the values equivalent to the fractional portions thereof into account.

The half tone processing module 210c grasps values before γ correction by γ interpretation and performs half tone processing, as mentioned above. Therefore, processing can be performed so that γC₀ will result in dot count h and γ(C₀+1) will result in dot count h+100. At the same time, processing can be performed so that gradation values γC₀+1 to γC₀+9 between them will result in dot counts h+10 to h+90. That is, the minimum pitch of dot count is remarkably reduced. According to the present invention, correction is carried out so that the smaller a gradation value is, the larger the original value will be, by a γ curve convex upward, as mentioned above. Therefore, subtler variation in color can be represented in the high-lightness range wherein the coefficient of fluctuation in lightness to ink recording rate, when half tone processing is performed. Therefore, tone jump can be reduced.

(4) Modifications:

The above-mentioned embodiment is an example. Various constitutions can be adopted as long as the following condition is satisfied: it should be possible to make the resolution in the high-lightness range relatively higher than the resolution in the low-lightness range. The number of gradation levels obtained after the γ correction is not limited to nine levels. More specific description will be given. When the accuracy is enhanced in the high-lightness range, the number of gradation levels which can be represented is reduced in the low-lightness range. Accordingly, γ correction can be carried out so that the most convenient situation will be obtained in terms of the balance between them. In reality, color conversion can be carried out with high accuracy even with such a constitution that the resolution in the high-lightness range is enhanced to three times or so at the maximum as compared with conventional cases by the γ correction. More specifically, color conversion can be carried out with high accuracy even by correcting a gradation value of “1” in CMYKlclm data to a gradation value of “3.”

Further, with an algorithm wherein correction is carried out by the same γ curve with respect to all the colors of CMYKlclm, γ correction can be carried out by very simple calculation. Needless to add, however, different γ curves may be used for different colors. Further, the γ curve maybe changed depending on printing medium or print mode. In these cases, a different color conversion table is generated with respect to each γ curve. Then, at the γ interpretation portion, interpretation corresponding to the individual color conversion tables is carried out, and half tone processing is performed.

In the above-mentioned embodiment, data obtained by carrying out color separation is subjected to γ correction. However, it is not indispensable to utilize data which underwent color separation. More specific description will be given. In the present invention, it only has to be possible to do the following: to make a definition so that an input gradation value corresponding to a higher-lightness range will be reduced in variation in the ink recording rate corresponding to the unit variation in that input gradation value as compared with input gradation values corresponding to a lower-lightness range, when half tone processing is performed; and to perform print operation. Therefore, objects of color measuring obtained by a technique other than color separation may be subjected to correction to acquire ink value data.

We claim:

1. A color conversion table generating method wherein a plurality of patches outputted from a printing device are subjected to color measuring and a color conversion table which defines the correspondence between the color component values of various colors used in another image device and ink value data corresponding to the ink quantities of inks in individual ink colors used in the printing device is generated based on the result of the color measuring, the method comprising:
a step for extracting a smaller number of reference values than the total number of gradations in said ink value data with respect to each ink color and combining them thereby to create patch data which specifies a plurality of said patches;
a step for performing half tone processing where the patch data is inputted and transformed into half tone image data which indicates the presence or absence of ink dots to print a plurality of said patches; and
a step for generating said color conversion table based on color measuring data obtained by subjecting a plurality of the printed patches to color measuring,
wherein
the colors in said patch data are colors obtained by extracting a smaller number of reference values before correction than the total number of gradations in predetermined gradation values before correction from the gradation values before correction with respect to each ink color and combining the reference values before correction, carrying out correction for interpolation accuracy enhancement to increase the reference values before correction, and thereby bringing the magnitude of values after the correction and the ink quantity into substantially linear correspondence with each other;
wherein
said ink value data is defined so that a gradation value which is an integral value existing in a predetermined range of value and corresponds to a higher-lightness range will be reduced in the ink recording rate corresponding to the unit variation in that gradation value as compared with gradation values corresponding to a lower-lightness range;
and wherein
in said half tone processing, ink quantities corresponding to the reference values in said patch data are interpreted according to the definition of the gradation values to generate said half tone image data.

2. The color conversion table generating method according to claim 1, wherein said ink value data is defined by allocating the total number of gradations to part of the range of value of ink recording rate.

3. A color conversion table generating method for generating a color conversion table which defines the correspondence between ink value data which specifies the ink quantities of inks in individual colors used in a printing device and the color component values of various colors used in another image device, the method comprising:
a step for extracting gradation values where the ink quantity and the magnitude of the gradation values are in substantially linear correspondence with each other with respect to each ink color and combining them to create first gradation value data;
a step for subjecting the first gradation value data to correction for resolution enhancement with a higher rate of increase applied to a gradation value corresponding to a high-lightness range than to gradation values corresponding to a lower-lightness range to obtain said ink value data;
a step for performing half tone processing, taking into account deviations equivalent to fractional portions obtained when the ink value data is subjected to correction inverse to said correction for resolution enhancement to perform print operation; and
a step for generating a color conversion table where said ink value data and the color component values of various colors used in said another image device are in correspondence with each other based on color measuring data obtained by subjecting the result of the print operation to color measuring;
wherein,
said first gradation value data is extracted beforehand so that colors in the low-lightness range will be larger in number than colors in the high-lightness range so as to compensate the resolution which is relatively degraded in the low-lightness range by said correction for resolution enhancement by interpolation accuracy.

4. The color conversion table generating method according to claim 3, wherein the gradation values in said first gradation value data are created based on data obtained by transforming coordinates in a predetermined color space constituted of a smaller number of color components than the number of ink colors into gradation values which indicate the quantities of individual color inks by a predetermined transformation expression.

5. The color conversion table generating method according to claim 3, wherein the gradation values in said first gradation value data are obtained by subjecting gradation values where the ink quantity and the magnitude of gradation values are in substantially linear correspondence with each other to γ correction where a smaller gradation value is corrected with a higher rate of increase as compared with larger gradation values and the result of the correction is outputted.

6. The color conversion table generating method according to claim 3, wherein a gradation value which indicates the lowest lightness in said first gradation value data is equivalent to the highest ink recording rate at which the ink can be recorded on a printing medium; and in said correction for resolution enhancement, a predetermined gradation value range containing the gradation value which indicates the lowest lightness is excluded and the correction is carried out so that the remaining gradation value range will be matched with the whole gradation value range of said ink value data.

7. A print controller which refers to a color conversion table which defines the correspondence between ink value data which specifies the ink quantities of inks in individual colors used in a printing device and the color component values of various colors used in another image device, and creates print data which indicates output images on the printing device from image data which indicates display images on the image device and causes print operation to be performed, the controller comprises:
an image data acquiring unit for acquiring image data where the color at each pixel in a matrix pattern is rendered with gradations with respect to images on said another image device;
a color converting unit which extracts gradation values where the ink quantity and the magnitude of gradation values are in substantially linear correspondence with each other with respect to each ink color and combines the gradation values to create first gradation value data, subjects the first gradation value data to correction for resolution enhancement with a higher rate of increase applied to a gradation value corresponding to a higher-lightness range than to gradation values corresponding to a lower-lightness range to obtain said ink value data, subjects the ink value data to half tone processing, taking into account deviations equivalent to fractional portions obtained when correction inverse to said correction for resolution enhancement is carried out, and performs print operation, generates a color conversion table where said ink value data and the color component values of various colors used in said another image device are in correspondence with each other based on color measuring data obtained by subjecting the result of the print operation to color measuring, said first gradation value data being extracted beforehand so that colors in the low-lightness range will be larger in number than colors in the high-lightness range so as to compensate the resolution which is relatively degraded in the low-lightness range by said correction for resolution enhancement by interpolation accuracy, and refers to the thus generated color conversion table to color-convert said image data into corresponding ink value data;
a half tone processing unit for interpreting ink quantities indicated by the ink value data from the color-converted ink value data and transforming the ink quantities into pseudo half tone data where gradations are represented by the recording density of ink droplets recorded on a printing medium;
a print data creating unit which creates print data for driving and causing the printing device to discharge ink droplets according to the recording density specified by said pseudo half tone data with respect to each pixel; and
a print data outputting unit for outputting the print data to the printing device.

8. A color conversion table generator which generates a color conversion table which defines the correspondence between ink value data which specifies the ink quantities of inks in individual colors used in a printing device and the color component values of various colors used in another image device, the generator comprise:
a first gradation value data acquiring unit for acquiring first gradation value data obtained by extracting gradation values where the ink quantity and the magnitude of gradation values are in substantially linear correspondence with each other with respect to each ink color and combining the gradation values;
an ink value data acquiring unit for subjecting the first gradation value data to correction for resolution enhancement with a higher rate of increase applied to a gradation value corresponding to a higher-lightness range than to gradation values corresponding to a lower-lightness range to acquire the result of the correction as said ink value data;
a print operation performing unit for performing half tone processing, taking into account deviations equivalent to fractional portions obtained when the ink value data is subjected to correction inverse to said correction for resolution enhancement to perform print operation;
a print result color measuring unit for subjecting the result of the print operation to color measuring; and
a color conversion table generating unit for generating a color conversion table where said ink value data and the color component values of various colors used in said another image device are in correspondence with each other based on color measuring data obtained by subjecting the result of the print operation to color measuring,
wherein
said first gradation value data is extracted beforehand so that colors in the low-lightness range will be larger in number than colors in the high-lightness range so as to compensate the resolution which is relatively degraded in the low-lightness range by said correction for resolution enhancement by interpolation accuracy.

9. A medium with a color conversion table generating program recorded thereon for generating a color conversion table which defines the correspondence between ink value data which specifies the ink quantities of inks in individual colors used in a printing device and the color component values of various colors used in another image device, wherein the program causes a computer to carry out:
a first gradation value data acquiring function of acquiring first gradation value data obtained by extracting gradation values where the ink quantity and the magnitude of the gradation values are in substantially linear correspondence with each other with respect to each ink color and combining the gradation values;
an ink value data acquiring function of subjecting the first gradation value data to correction for resolution enhancement with a higher rate of increase applied to a gradation value corresponding to a higher-lightness range than to gradation values corresponding to a lower-lightness range and acquiring the result of the correction as said ink value data;
a print operation performing function of performing half tone processing, taking into account deviations equivalent to fractional portions obtained when the ink value data is subjected to correction inverse to said correction for resolution enhancement, and performing print operation;
a print result color measuring function of subjecting the result of the print operation to color measuring; and
a color conversion table generating function of generating a color conversion table where said ink value data and the color component values of various colors used in said another image device are correspondence with each other based on color measuring data obtained by subjecting the result of the print operation to color measuring; wherein
said first gradation value data is extracted beforehand so that colors in the low-lightness range will be larger in number than colors in the high-lightness range so as to compensate the resolution which is relatively degraded in the low-lightness range by said correction for resolution enhancement by interpolation accuracy.

10. A correspondence definition data creating method for creating correspondence definition data which defines the correspondence between ink color-by-ink color input gradation values to be inputted to a half tone processing module and the color component values of various colors used in another image device, the method comprising:
a step for creating said correspondence definition data by taking integral values existing in a predetermined range of value as said input gradation values; defining the input gradation values so that an input gradation value corresponding to a higher-lightness range will be reduced in variation in the ink recording rate corresponding to the unit variation in that input gradation value as compared with input gradation values corresponding to a lower-lightness range; and bringing colors indicated by combinations of input gradation values and colors indicated by combinations of said color component values into correspondence with each other with respect to each ink color.

11. A correspondence definition data creating method wherein a plurality of patches outputted from a printing device are subjected to color measuring, and correspondence definition data which defines the correspondence between the color component values of various colors used in another image device and gradation values corresponding to the ink quantities of inks in individual colors used in the printing device is created based on the result of the color measuring, the method comprising:
a step for extracting a smaller number of reference values than the total number of gradations in gradation values corresponding to said ink quantities with respected to each ink color and combining them thereby to create patch data which specifies a plurality of said patches;
a step for performing half tone processing where the patch data is inputted and transformed into half tone image data which indicates the presence or absence of ink dots to print a plurality of said patches; and
a step for creating said correspondence definition data based on color measuring data obtained by subjecting a plurality of the printed patches to color measuring,
wherein
gradation values corresponding to said ink quantities are so defined that a gradation value which is an integral value existing in a predetermined range of value and corresponds to a higher-lightness range will be reduced in the ink recording rate corresponding to the unit variation in that gradation value as compared with gradation values corresponding to a lower-lightness range;
and wherein
in said half tone processing, ink quantities corresponding to reference values in said patch data are interpreted according to the definition of the gradation values to generate said half tone image data.

12. The correspondence definition data creating method according to claim 11, wherein said gradation values corresponding to ink quantities are defined by allocating the total number of gradations to part of the range of value of ink recording rate.

13. A correspondence definition data creating method for creating correspondence definition data which defines the correspondence between ink value data which specifies the ink quantities of inks in individual colors used in a printing device and the color component values of various colors used in another image device, the method comprising:
a step for converting colors rendered by combinations of CMY colors to acquire first gradation value data where the magnitude of gradation values and the ink quantity are in substantially linear correspondence with each other;
a step for subjecting the first gradation value data to γ correction with a higher rate of increase applied to a smaller gradation value to create ink value data where the resolution in the high-lightness range is relatively enhanced;
a step for subjecting the result of print operation performed with said printing device based on the ink value data to color measuring; and
a step for creating correspondence definition data which defines the correspondence between said ink value data and the color component values of various colors used in said another image device from the result of the color measuring.

14. A correspondence definition data creating method for creating correspondence definition data which defines the correspondence between ink value data which specifies the ink quantities of inks in individual colors used in a printing device and the color component values of various colors used in another image device, the method comprising:
a step for performing print operation with a plurality of pieces of ink value data which specify said ink quantities of inks in individual colors, obtained by subjecting first gradation value data where the ink quantity and the magnitude of gradation values are in substantially linear correspondence with each other to correction with a higher rate of increase applied to a gradation value corresponding to a higher-lightness range than to gradation values corresponding to a lower-lightness range; and
a step for creating correspondence definition data where said ink value data and the color component values of various colors used in said another image device are in correspondence with each other based on color measuring data obtained by subjecting the result of the print operation to color measuring.

15. The correspondence definition data creating method according to claim 14, wherein said ink value data is data obtained by correcting said first gradation value data which indicates color components in a predetermined first color space by a predetermined transformation expression; and when said print operation is performed, half tone processing is performed, taking into account deviations equivalent to fractional portions obtained when correction inverse to the above correction is carried out.

16. The correspondence definition data creating method according to claim 14, wherein said correction is γ correction where a smaller input value is corrected with a higher rate of change and the result of the correction is outputted.

17. The correspondence definition data creating method according to claim 14, wherein a gradation value which indicates the lowest lightness in said first gradation value data is equivalent to the highest ink recording rate at which the ink can be recorded on a printing medium; and in said correction, a predetermined gradation value range containing the gradation value which indicates the lowest lightness is excluded and the correction is carried out so that the remaining gradation value range will be matched with the whole gradation value range of said ink value data.

18. A print controller which refers to a correspondence definition data which defines the correspondence between ink value data which specifies the ink quantities of inks in individual colors used in a printing device and the color component values of various colors used in another image device, and creates print data which indicates output images on the printing device from image data which indicates display images on the image device and causes print operation to be performed, the controller comprising:
an image data acquiring unit for acquiring image data where the color at each pixel in a matrix pattern is rendered with gradations with respect to images on said another image device;
a color converting unit which performs print operation with a plurality of pieces of ink value data which specify said ink quantities of inks in individual colors, obtained by correcting first gradation value data where the ink quantity and the magnitude of gradation values are in substantially linear correspondence with each other with a higher rate of increase applied to a gradation value corresponding to a higher-lightness range than to gradation values corresponding to a lower-lightness range; refers to correspondence definition data where said ink value data and the color component values of various colors used in said another image device are in correspondence with each other, based on color measuring data obtained by subjecting the result of the print operation to color measuring; and color-converts said image data into corresponding ink value data;
a half tone processing unit which interprets ink quantities indicated by the ink value data from the color-converted ink value data and transforms the ink quantities into pseudo half tone data where gradations are represented by the recording density of ink droplets recorded on a printing medium;
a print data creating unit which creates print data for driving and causing the printing device to discharge ink droplets according to the recording density specified by said pseudo half tone data; and
a print data outputting unit which outputs the print data to the printing device.

19. A correspondence definition data creating apparatus for creating correspondence definition data which defines the correspondence between ink value data which specifies the ink quantities of inks in individual color used in a printing device and the color component values of various colors used in another image device, the apparatus comprising:
a color separation unit which transforms colors rendered by combinations of CMY colors into first gradation value data where the magnitude of gradation values and the ink quantity are in substantially linear correspondence with each other;
an ink value data creating unit which subjects the first gradation value data to γ correction with a higher rate of increase applied to a smaller gradation value to create ink value data where the relative resolution in the high-lightness range is enhanced;
a print operation performing unit which creates print data which specifies ink quantities according to the ink value data and performs print operation with said printing device;
a print result color measuring unit which subjects the result of the print operation to color measuring; and
a correspondence definition data creating unit which creates correspondence definition data which defines the correspondence between said ink value data and the color component values of various colors used in said another image device from the result of the color measuring.

20. A correspondence definition data creating apparatus for creating correspondence definition data which defines the correspondence between ink value data which specifies the ink quantities of inks in individual colors used in a printing device and the color component values of various colors used in another image device, the comprising:
an ink value data acquiring unit which acquires a plurality of pieces of ink value data which specify said ink quantities of inks in individual colors obtained by correcting first gradation value data where the ink quantity and the magnitude of gradation values are in substantially linear correspondence with each other with a higher rate of increase applied to a gradation value corresponding to a higher-lightness range than to gradation values corresponding to a lower-lightness range;
a print operation performing unit which performs print operation with ink quantities specified by the ink value data;
a color measuring data acquiring unit which subjects the result of the print operation to color measuring to acquire color measuring data; and
a correspondence definition data creating unit which brings said ink value data and the color component values of various colors used in said another image device into correspondence with each other based on the color measuring data to create correspondence definition data.

21. A medium with a correspondence definition data recorded thereon for creating correspondence definition data which defines the correspondence between ink value data which specifies the ink quantities of inks in individual colors used in a printing device and the color component values of various colors used in another image device, the program causes a computer to carry out:
a color separation function of transforming colors rendered by combinations of CMY colors into first gradation value data where the magnitude of gradation values and the ink quantity are in substantially linear correspondence with each other;
an ink value data creating function of subjecting the first gradation value data to γ correction with a higher rate of increase applied to a smaller gradation value to create ink value data where the relative resolution in the high-lightness range is enhanced;
a print operation performing function of creating print data which specifies ink quantities according to the ink value data and performing print operation with said printing device;
a print result color measuring function of subjecting the result of the print operation to color measuring; and
a correspondence definition data creating function of creating correspondence definition data which defines the correspondence between said ink value data and the color component values of various colors used in said another image device from the result of the color measuring.

22. A medium with a correspondence definition data creating program recorded thereon for creating correspondence definition data which defines the correspondence between ink value data which specifies the ink quantities of inks in individual colors used in a printing device and the color component values of various colors used in another image device, the program causes a computer to carry out:
an ink value data acquiring function of acquiring a plurality of pieces of ink value data which specify said ink quantities of inks in individual colors obtained by correcting first gradation value data where the ink quantity and the magnitude of gradation values are in substantially linear correspondence with each other with a higher rate of increase applied to a gradation value corresponding to a higher-lightness range than to gradation values corresponding to a lower-lightness range;
a print operation performing function of performing print operation with ink quantities specified by the ink value data;
a color measuring data acquiring function of subjecting the result of the print operation to color measuring to acquire color measuring data; and
a correspondence definition data creating function of bringing said ink value data and the color component values of various colors used in said another image device in correspondence with each other based on the color measuring data to create correspondence definition data.
